(19) United States
(12) Patent Application Publication
(10) Pub. No.: US 2021/0127361 A1
(43) Pub. Date: Apr. 29, 2021

(54) USER EQUIPMENT AND TRANSMISSION METHOD

(71) Applicant: NTT DOCOMO, INC., Tokyo (JP)

(72) Inventors: Shimpei Yasukawa, Tokyo (JP); Satoshi Nagata, Tokyo (JP); Qun Zhao, Beijing (CN); Huiling Jiang, Beijing (CN); Liu Liu, Beijing (CN); Anxin Li, Beijing (CN)

(73) Assignee: NTT DOCOMO, INC., Tokyo (JP)

(21) Appl. No.: 16/074,152

(22) PCT Filed: Jan. 25, 2017
(86) PCT No.: PCT/JP2017/002586

§ 371 Date: Jul. 31, 2018

(30) Foreign Application Priority Data
Feb. 4, 2016 (JP) 2016-020327

(51) Int. Cl. H04W 72/02; H04W 72/04; H04W 28/26; H04W 4/70; H04W 4/40

(52) U.S. Cl. CPC H04W 72/02; H04W 72/0406; H04W 72/0446; H04W 4/40; H04W 28/26; H04W 4/70; H04W 72/0453

(57) ABSTRACT

A user equipment in a wireless communication system that supports D2D communication includes: a selection unit that selects a first control information resource for transmitting control information from a control information resource pool and selects a first data resource for transmitting data from a data transmission resource pool among radio resources in which the control information resource pool and the data transmission resource pool are continuously set without any limitation in a time direction; and a transmission unit that transmits control information including information that designates the first data resource by using the first control information resource and transmits data by using the first data resource.

### TECHNICAL FIELD

The present invention relates to a user equipment and a transmission method.

### BACKGROUND ART

In LTE (Long Term Evolution) or LTE successor systems (for example, also referred to as LTE-A (LTE Advanced), 4G, FRA (Future Radio Access), or the like), a D2D (Device to Device) technique for allowing user equipments to perform direct communication without via a radio base station has been discussed (see, Non-Patent Document 1).

D2D reduces the traffic between user equipments and a base station and enables communication to be performed between user equipments even when the base station falls into an incommunicable state in the event of a disaster or the like.

D2D is broadly classified into D2D discovery for discovering another communicable user equipment and D2D communication (also referred to as D2D direct communication or terminal-to-terminal direct communication) for allowing direct communication to be performed between user equipments. In the following description, D2D communication and D2D discovery are referred to simply as D2D when both are not particularly distinguished from each other. Moreover, signals transmitted and received by D2D are referred to as D2D signals.

In 3GPP (3rd Generation Partnership Project), it is discussed to realize V2X by expanding the D2D function. Here, V2X is a part of ITS (Intelligent Transport Systems), and as illustrated in FIG. 1, is a generic term of V2V (Vehicle to Vehicle) meaning a form of communication performed between vehicles, V2I (Vehicle to Infrastructure) meaning a form of communication performed between a vehicle and a PSU (Road-Side Unit) provided on the roadside, V2N (Vehicle to Nomadic device) meaning a form of communication performed between a vehicle and a mobile terminal of a driver, and V2P (Vehicle to Pedestrian) meaning a form of communication performed between a vehicle and a mobile terminal of a pedestrian.

### CITATION LIST

### Non-Patent Document

Non-Patent Document 1: “Key drivers for LTE success: Services Evolution”, September 2011, 3GPP, Internet URL: http://www.3gpp.org/ftp/Information/presentations/presentat ions_2011/2011_09_LTE_Asia/2011_LTE-Asia_3GPP_Service_evolution.pdf
Non-Patent Document 2: 3GPP TS 36.300 V13.2.0 (2015-12)

### SUMMARY OF THE INVENTION

### Problem to be Solved by the Invention

In conventional D2D, a PSSCH (Physical Sidelink Shared Channel) resource pool which is a range of radio resources for transmitting data and a PSCCH (Physical Sidelink Control Channel) resource pool which is a range of radio resources for transmitting control information (SCI: Sidelink Control Information) are cyclically set in a time-multiplexed manner. The cycle is referred to as a SC (Sidelink Control) period and the cycle is defined to be 40 ms or larger.

A transmission-side user equipment transmits control information (SCI) by using a radio resource selected from the PSCCH resource pool and transmits data by using a radio resource selected from the PSSCH resource pool. The control information includes information indicating the location or the like of the radio resource selected from the PSSCH resource pool. Therefore, a timing at which the transmission-side user equipment can transmit new data is influenced by the length of the SC period and the configuration of the PSCCH/PSSCH resource pool.

Here, V2X discusses various resource pool configurations for flexibly controlling the timings at which control information and data can be transmitted. As an example, a resource pool configuration in which a resource pool for transmitting control information and a resource pool for transmitting data are frequency-multiplexed is discussed.

FIGS. 2 and 3 are diagrams for describing problems. FIGS. 2 and 3 illustrate a resource pool configuration in which a resource pool (hereinafter referred to as a “SCI resource pool”) for transmitting control information and a resource pool (hereinafter referred to as a “data resource pool”) for transmitting data are time-multiplexed and frequency-multiplexed in a SC period. FIG. 2 illustrates a case in which the period of the SCI resource pool is the same as the period of the data resource pool and FIG. 3 illustrates a case in which the period of the data resource pool is longer than the period of the SCI resource pool.

For example, in the resource pool configuration illustrated in FIG. 2, when a radio resource to be used for transmitting data corresponding to SCI is selected, there is a restriction that a user equipment needs to select a radio resource from a data resource pool in the same SC period as the SCI resource pool. For example, when it is assumed that the data resource pool is 20 is, the user equipment cannot select a radio resource for transmitting data four times at an interval of 10 ms using one item of SCI. Therefore, as illustrated in FIG. 3, a resource pool configuration in which the period of the data resource pool is longer than the SCI resource pool may be employed. However, in the resource pool configuration illustrated in FIG. 3, since two data resource pools overlap in a partial period, the radio resources of the data transmitted from a plurality of user equipments may overlap and a collision may occur.

Since D2D communication is a half-duplex communication method in which D2D signals are transmitted and received using the same carrier, a user equipment cannot transmit and receive D2D signals in the same subframe simultaneously. That is, as illustrated in FIGS. 2 and 3, when a subframe in which control information (SCI) is transmitted from UE1 (user equipment 1) is the same as a subframe in which data is transmitted from UE2 (user equipment 2), the UE1 cannot receive data transmitted from the UE2. Moreover, regarding that V2X is one kind of D2D, the above-mentioned problems can occur in general D2D.

The disclosed technique has been in view of the above-described circumstance, and an object thereof is to provide a technique capable of performing D2D communication more flexibly.

### Means for Solving Problem

A user equipment of the disclosed technique is a user equipment in a wireless communication system that supports D2D communication, including: a selection unit that selects a first control information resource for transmitting control information from a control information resource pool and selects a first data resource for transmitting data from a data transmission resource pool among radio resources in which the control information resource pool and the data transmission resource pool are continuously set without any limitation in a time direction; and a transmission unit that transmits control information including information that designates the first data resource using the first control information resource and transmits data using the first data resource.

### Effect of the Invention

According to the disclosed technique, a technique capable of performing D2D communication more flexibly is provided.

### BRIEF DESCRIPTION OF DRAWINGS

FIG. 1 is a diagram for describing V2X;

FIG. 2 is a diagram for describing problems;

FIG. 3 is a diagram for describing problems;

FIG. 4A is a diagram for describing D2D;

FIG. 4B is a diagram for describing D2D;

FIG. 5 is a diagram for describing a MAC PDU used in D2D communication;

FIG. 6 is a diagram for describing the format of a SL-SCH subheader;

FIG. 7 is a diagram illustrating a configuration example of a wireless communication system according to an embodiment;

FIG. 8 is a diagram illustrating a physical configuration example of a SCI resource pool and a data resource pool;

FIG. 9A is a diagram for describing a first example of a SCI repeat transmission method;

FIG. 9B is a diagram for describing a first example of a SCI repeat transmission method;

FIG. 10 is a diagram for describing a second example of a SCI repeat transmission method;

FIG. 11 is a diagram for describing a second example of a SCI repeat transmission method;

FIG. 12 is a diagram for describing a data repeat transmission method;

FIG. 13 is a diagram for describing a SCI transmission resource reservation method;

FIG. 14 is a diagram for describing a data transmission resource reservation method;

FIG. 15 is a diagram illustrating a first specific example of a reservation method for reserving resources for transmitting SCI and data;

FIG. 16 is a diagram illustrating a second specific example of a reservation method for reserving resources for transmitting SCI and data;

FIG. 17 is a diagram illustrating an example of a functional configuration of a user equipment according to an embodiment;

FIG. 18 is a diagram illustrating an example of a functional configuration of a base station according to an embodiment;

FIG. 19 is a diagram illustrating an example of a hardware configuration of a user equipment according to an embodiment; and

FIG. 20 is a diagram illustrating an example of a hardware configuration of a base station according to an embodiment.

### MODE(S) FOR CARRYING OUT THE INVENTION

Hereinafter, an embodiment of the invention will be described with reference to the drawings. The embodiment to be described below is an example only, and an embodiment to which the invention is applied is not limited to the following embodiment. For example, although a wireless communication system according to the present embodiment is a system of a scheme compatible with LTE, the invention is not limited to LTE but can be applied to other schemes. In the present specification and the claims, “LTE” is used in a broad sense to include 5G communication schemes corresponding to 3GPP release 10, 11, 12, 13, 14, or later as well as communication schemes corresponding to 3GPP release 8 or 9.

Although the present embodiment is mainly directed to V2X, the technique according to the present embodiment is not limited to V2X but can be broadly applied to general D2D. Moreover, “D2D” is meant to include V2X.

“D2D” is used in a broad sense to include a processing procedure in which a D2D signal is transmitted and received between user equipments UEs, a processing procedure in which a base station receives (monitors) D2D signals, and a processing procedure in which a user equipment UE transmits an uplink signal to a base station eNB in a RRC idle state or a state in which connection with a base station eNB is not established.

In the following description, although control information used in D2D communication is referred to as “SCI,” the present invention is not intended to be limited to this. In the present embodiment, control information called by the name of “SA (Scheduling Assignment)” which is used in the conventional D2D also falls into the control information of the present embodiment. Moreover, if another term is newly defined in V2X and the terminal means the control information used in D2D communication, the term also falls into the control information of the present embodiment.

<Overview of D2D>

First, an overview of D2D defined in LTE will be described. V2X can also use the technique of D2D described herein, and a UE of the embodiment of the present invention can transmit and receive a D2D signal according to the technique.

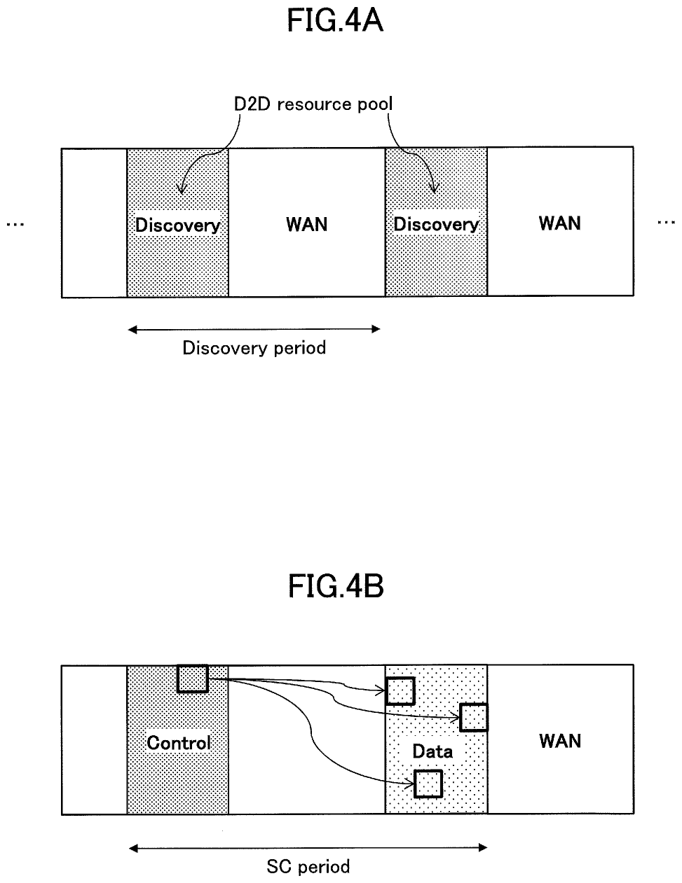

As described above, D2D is broadly classified into “D2D discovery” and “D2D communication”. As illustrated in FIG. 4A, in “D2D discovery,” a resource pool for discovery messages is secured for each discovery period and a UE transmits a discovery message in the resource pool. More specifically, the “D2D discovery” comes in Type 1 and Type 2b. In Type 1, a UE autonomously selects a transmission resource from a resource pool. In Type 2b, a semistatic resource is allocated by higher-layer signaling (for example, a RRC signal).

In “D2D communication,” SCI/data transmission resource pools are cyclically secured as illustrated in FIG. 4B. The cycle is called a SC period. A transmission-side UE notifies a data transmission resource or the like to the reception side using SCI by using a resource selected from a control resource pool (a SCI transmission resource pool) and transmits data by using the data transmission resource. More specifically, the “D2D communication” comes in Mode 1 and Mode 2. In Mode 1, resources are dynamically allocated by (E)PDCCH transmitted from an eNB to a UE. In Mode 2, a UE autonomously selects a transmission resource from a resource pool. A resource pool notified using SIB or a predetermined resource pool is used as the resource pool.

In LTE, a channel used in “D2D discovery” is referred to as PSDCH (Physical Sidelink Discovery Channel), a channel used for transmitting control information such as SCI in “D2D communication” is referred to as PSCCH (Physical Sidelink Control Channel), and a channel used for transmitting data is referred to as PSSCH (Physical Sidelink Shared Channel) (see Non-Patent Document 2).

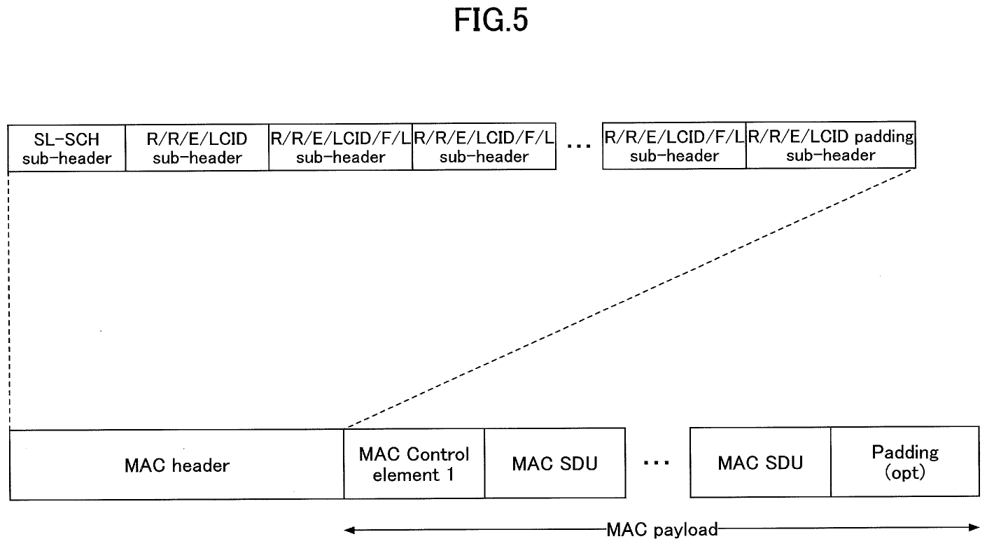

A MAC (Medium Access Control) PDU (Protocol Data Unit) used in D2D communication includes at least a MAC header, a MAC control element, a MAC SDU (Service Data Unit), and padding as illustrated in FIG. 5. The MAC PDU may include other information. The MAC header includes one SL-SCH (Sidelink Shared Channel) subheader and one or more MAC PDU subheaders.

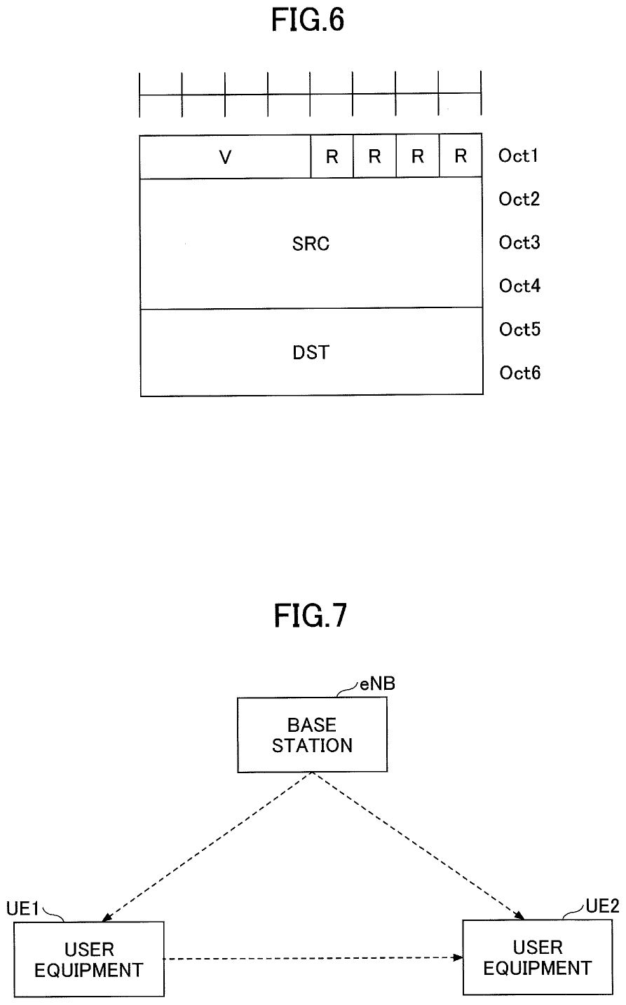

As illustrated in FIG. 6, the SL-SCH subheader includes a MAC PDU format version (V), transmission source information (SRC), transmission destination information (DST), a reserved bit (R), and the like. V is allocated to the start of the SL-SCH subheader and indicates a MAC PDU format version used by a UE. Information on a transmission source is set to the transmission source information. An identifier of a ProSe UE ID may be set to the transmission source information. Information on a transmission destination is set to the transmission destination information. Information on a ProSe Layer-2 Group ID of a transmission destination may be set to the transmission destination information.

<System Configuration>

FIG. 7 is a diagram illustrating a configuration example of a wireless communication system according to an embodiment. As illustrated in FIG. 7, the wireless communication system according to the present embodiment includes a base station eNB, a user equipment UE1, and a user equipment UE2. In FIG. 7, although it is intended that the user equipment UE1 is a transmission side and the user equipment UE2 is a reception side, the user equipment UE1 and the user equipment UE2 both may have both a transmission function and a reception function. Hereinafter, the user equipment UE1 and the user equipment UE2 will be described simply as a “user equipment UE” when the user equipments are not particularly distinguished from each other.

The user equipment UE1 and the user equipment UE2 illustrated in FIG. 7 each have a cellular communication function of a user equipment UE in LTE and a D2D function including transmission and reception of signals in the above-described channel. Moreover, the user equipment UE1 and the user equipment UE2 have a function of executing operations to be described in the present embodiment. The user equipments UEs may have all or some of the cellular communication function and the existing D2D function (within a range in which the operations to be described in the present embodiment can be executed).

Although the user equipments UEs may be arbitrary devices having the D2D function, the user equipments UEs are terminals, RSUs (UE-type RSUs having the function of the UE) provided in or held by vehicles or pedestrians.

The base station eNB has a cellular communication function of a base station eNB in LTE and functions (a resource allocation function, a configuration information notification function, and the like) for enabling communication of user equipments UEs in the present embodiment. Moreover, the base station eNB includes a RSU (an eNB-type RSU having the function of an eNB).

<Overview>

As described above with reference to FIG. 4B, in the conventional D2D, the SCI/data resource pool is cyclically set in respective SC periods. On the other hand, in the present embodiment, the concept of the SC period is excluded in order to flexibly control a resource for transmitting a D2D signal and the SCI resource pool and the data resource pool are continuously set without any limitation in the time direction (that is, without providing any temporal break unlike the SC period).

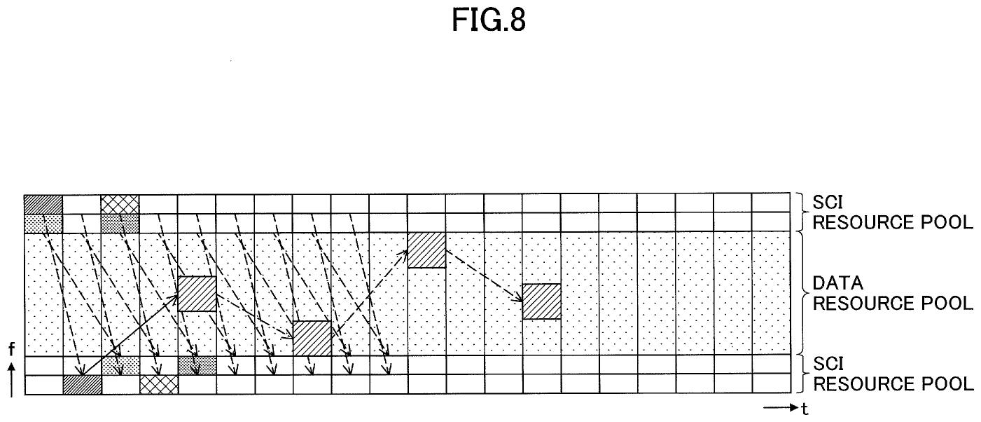

FIG. 8 is a diagram illustrating a physical configuration example of a SCI resource pool and a data resource pool. As illustrated in FIG. 8, in the present embodiment, the SCI resource pool and the data resource pool are continuously set unlimitedly in the time direction. Moreover, the SCI resource pool is set in the upper and lower regions of a region in which the data resource pool is set. The setting of the SCI resource pool and the data resource pool may be notified from a base station eNB to a user equipment UE using notification information (SIB) or RRC signaling and may be pre-configured in a user equipment UE by a SIM (Subscriber Identity Module), a core network, or the like.

In the conventional D2D, it is defined so that the same SCI/data is repeatedly transmitted (hop-transmitted) in the SCI/data resource pool in the SC period. However, in the present embodiment, since the concept of the SC period is excluded, a new SCI/data repeat transmission method is defined.

The user equipment UE repeatedly transmits the same SCI between the upper-side SCI resource pool and the lower-side SCI resource pool illustrated in FIG. 8 using frequency hopping, which will be described in detail later.

In the present embodiment, the user equipment UE operates to repeatedly transmit the same data (MAC PDU) at a predetermined subframe interval. A specific method of determining the predetermined subframe interval will be described later.

<Processing Procedure>

### <First Example of SCI Repeat Transmission Method>

Next, a method of determining the location of a resource for transmitting each item of SCI when a user equipment UE repeatedly transmits SCI will be described.

Hereinafter, a case in which the user equipment UE repeatedly transmits SCI two times and a case in which SIC is repeatedly transmitted three or more times will be described. The number of times the user equipment UE repeatedly transmits SCI may be notified from the base station eNB to the user equipment UE using notification information (SIB) or RRC signaling and may be pre-configured in the user equipment UE by a SIM, a core network, or the like. Moreover, a different number of times may be designated to each user equipment UE and a different number of times may be designated to each cell or each SCI resource pool.

(Case in which SCI is Repeatedly Transmitted Two Times)

First, a resource determination method when SCI is repeatedly transmitted two times or more will be described. The user equipment UE transmits SCI using frequency hopping so that the resource of the SCI to be transmitted in the first round (the first time) and the resource of the SCI to be transmitted in the second round belong to different SCI resource pools (the upper-side SCI resource pool and the lower-side SCI resource pool illustrated in FIG. 8).

As described above, since the D2D communication is a half-duplex communication method in which a D2D signal is transmitted and received using the same carrier, the user equipment UE cannot transmit and receive the D2D signal simultaneously in the same subframe. That is, when a plurality of user equipments UEs transmits SCI in the same subframe, if the plurality of user equipments UEs repeatedly transmits SCI in the same subframe, the plurality of user equipments UEs cannot receive the SCI of the counterpart user equipment UE. Therefore, in the first example of the SCI repeat transmission method, the interval between the resource (a subframe) in a time direction of the SCI transmitted in the first round (first time) and the resource (a subframe) in the frequency direction of the SCI transmitted in the second round is determined based on the resource in the frequency direction of the SCI transmitted in the first round.

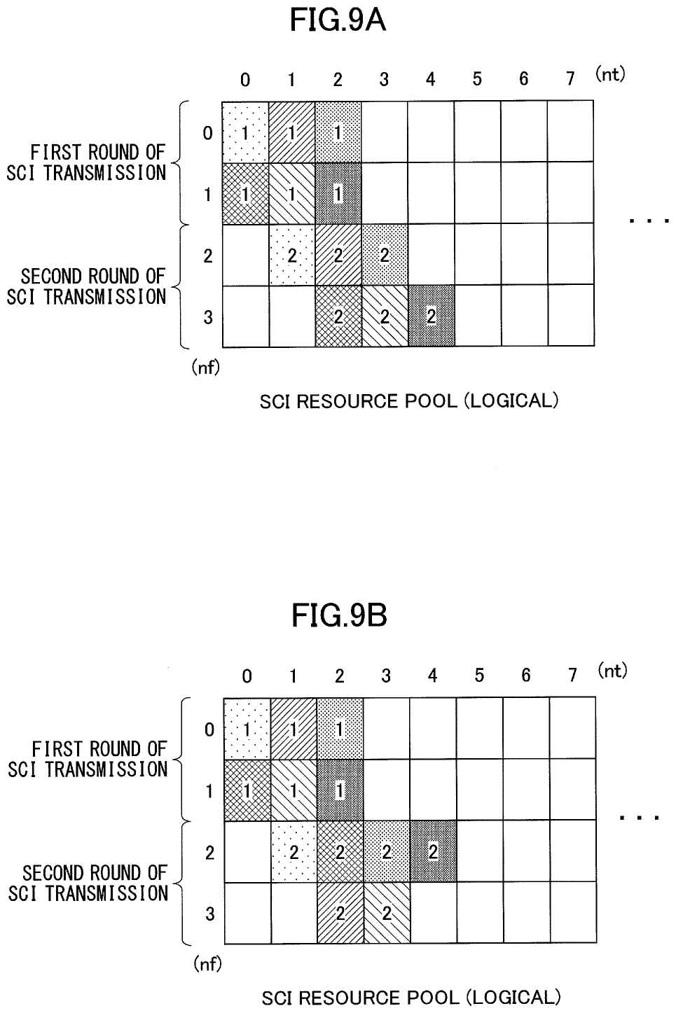

FIGS. 9A and 9B are diagrams for describing a first example of the SCI repeat transmission method. FIGS. 9A and 9B logically illustrate the SCI resource pool. That is, in a physical expression, the four resources (the resources indicated by “nf”=:0, 1, 2, and 3) in FIGS. 9A and 9B sequentially correspond to four resources present in the upper and lower-side SCI resource pools in FIG. 8. The resource indicated by “nf=0” in FIGS. 9A and 9B may correspond to the uppermost resource (the resource on the uppermost layer in FIG. 8) in the frequency direction of FIG. 8, and conversely, may correspond to the lowermost resource (the resource on the lowermost layer in FIG. 8) in the frequency direction of FIG. 8. One block illustrated in FIGS. 9A and 9B (the same is true to FIG. 8) means a resource block pair to be used for transmission of SCI. In FIG. 8 and FIGS. 9A and 9B, although a SCI resource pool includes four resource blocks in the frequency direction, this is an example only, and the SCI resource pool may include five or more resource blocks.

In FIGS. 7(a) and 7(b), “nt” means the location of a subframe and “nf” means the location of a resource block in the frequency direction. The “nt” is not intended to indicate a specific subframe number but is a variable indicating the relative location of a subframe. Similarly, the “nf” is a variable indicating the relative location of the resource block in the frequency direction.

In the first repeat transmission method, the user equipment UE selects a resource (nt1,nf1) at an arbitrary location among the rear resources in the upper-half part of FIGS. 9A and 9B as the resource of the SCI to be transmitted in the first round and determines the location (nt2,nf2) of the resource of the SCI to be transmitted in the second round using Equation 1 or 2. “Nf” means the number of resource blocks in the frequency direction included in the entire SCI resource pool (the same is true to Equations 3, 4, and 5 to be described later). In the example of FIGS. 9A and 9B, “Nf=4”.

(Equation 1)

nt2=nt1+nf1+1;

nf2=nf1+floor(Nf/2); [Math 1]

(Equation 2)

nt2=nt1+nf1+1;

nf2=floor(Nf/2)+mod(nft+nt1,floor(Nf/2)); [Math 2]

FIG. 9A illustrates an example of the resource locations of the first and second items of SCI when Equation 1 is used. As illustrated in FIG. 9A, for example, when the first item of SCI is transmitted using the resource of (nt,nf)=(0,0), the second item of SCI is transmitted using the resource of (nt,nf)=(1,2). Similarly, for example, when the first item of SCI is transmitted using the resource of (nt,nf)=(0,1), the second item of SCI is transmitted using the resource of (nt,nf)=(2,3).

FIG. 9B illustrates an example of the resource locations of the first and second items of SCI when Equation 2 is used. As illustrated in FIG. 9B, for example, when the first item of SCI is transmitted using the resource of (nt,nf)=(0,0), the second item of SCI is transmitted using the resource of (nt,nf):=(1,2). Similarly, for example, when the first item of SCI is transmitted using the resource of (nt,nf)=(0,1), the second item of SCI is transmitted using the resource of (nt,nf)=(2,2).

That is, when Equation 1 or 2 is used, the two items of SCI transmitted using the same subframe and the resources of different frequencies in the first round of transmission are transmitted in a subframe different from that in the second round of transmission. Moreover, the two items of SCI transmitted using different subframes and the resources of the same frequency in the first round of transmission are transmitted in the same subframe intervals as those in the second round of transmission. In other words, the location of the subframe of the SCI transmitted in the second round is determined based on the location of the resource in the frequency direction of the SCI transmitted in the first round.

In Equation 1, the SCI is transmitted using resources shifted by the same offset (an offset corresponding to two resources) in the frequency direction in the first and second rounds of transmission. In Equation 2, the offset in the frequency direction is distributed further in the first and second rounds of transmission. For example, in FIG. 9B, when the first item of SCI is transmitted using the resource of (nt,nf)=(0,0), the second item of SCI is transmitted using the resource of (nt,nf)=(1,2). That is, the offset in the frequency direction corresponds to two resources. On the other hand, when the first item of SCI is transmitted using the resource of (nt,nf)=(0,1), the second SCI is transmitted using the resource of (nt,nf)=(2,2). That is, the offset in the frequency direction corresponds to one resource. That is, when Equation 2 is used, the resources in the frequency direction are distributed to the first and second items of SCI transmitted in the first and second rounds.

(Case in which SCI is Repeated Transmitted Three or More Times)

Next, a resource determination method when SCI is repeatedly transmitted three or more times will be described. In the following description, the number of times SCI is repeatedly transmitted is defined as “K (K≥3)”.

[Case in which K is Even Number]

When K is an even number, the user equipment UE may repeatedly perform the resource determination method described in “(Case in which SCI is repeatedly transmitted two times)” “K/2” times. For example, when SCI is repeatedly transmitted six times, the user equipment UE may perform the resource determination method described in “(Case in which SCI is repeatedly transmitted two times)” three times.

Here, in the “(Case in which SCI is repeatedly transmitted two times),” the resource of the SCI transmitted in the first round is selected arbitrarily by the user equipment UE. When SCI is repeatedly transmitted three or more times and K is an even number, the location of the resource of SCI transmitted in the “2i+1”-th round (i=1, 2, 3, . . . ) (for example, when K=6, the location of the resource of SCI transmitted in the third and fifth rounds) may be determined according to Equation 3 below. In Equation 3, the value of nt(1) and nf(1) corresponds to the resource location when SCI is transmitted in the first round.

(Equation 3)

nt(i+1)=nt(i)+floor(Nf/2)*nf(i)

nf(i+1)=mod(nf(i)+c,floor(Nf/2))

c is a predetermined constant, i=1,2,3, . . . [Math 3]

Here, “c” is a predetermined integer and i is 1, 2, 3, . . . .

When Equation 3 is used, since the location (a hopping pattern) of the resource of SCI repeatedly transmitted is determined uniquely (fixedly) regardless of the user equipment UE, the reception-side user equipment UE can detect the resource locations of SCI transmitted a plurality of number of times in advance. That is, the reception-side user equipment UE can obtain a combination gain by combining a plurality of resources of SCI.

The location of the resource of SCI transmitted in the “2i+1”-th round (i=1, 2, 3, . . . ) may be determined using Equation 4 illustrated below. In Equation 4, “SA_ID” is an ID (SA ID: Sidelink group destination identity) allocated to a predetermined group of user equipments UEs.

(Equation 4)

nt(i+1)=nt(i)+floor(Nf/2)*mod(SA_ID,b)

nf(i+1)=mod(nf(i)+SA_ID+c,floor(Nf/2))

b,c are predetermined constants, i=1,2,3, . . . [Math 4]

Here, “b” and “c” are predetermined integers and i is 1, 2, 3, . . . .

When Equation 4 is used, the location (a hopping pattern) of the resource of SCI repeatedly transmitted changes for respective user equipments UEs of different groups. That is, when Equation 4 is used, even when a plurality of user equipments UEs of different groups selects the same resource as the resource for transmitting SCI in the first round, the locations of the resources of SCI transmitted in the third and subsequent rounds are distributed and collision of SCI can be avoided.

[Case in which K is Odd Number]

When K is an odd number, the user equipment UE may determine the location of the resource for transmitting SCI by the same method as the “Case in which K is even number” and may additionally transmit SCI one time. For example, when SCI is repeatedly transmitted seven times, the user equipment UE may determine the location of the resource of SCI transmitted in the first to sixth rounds by the resource determination method described in the “Case in which K is even number” and may additionally transmit SCI one time.

The last odd-numbered resource location among the resource locations determined using the same method as the resource determination method described in the “Case in which K is even number” may be used as the resource location of SCI additionally transmitted one time. For example, when SCI is repeatedly transmitted seven times, the user equipment UE may determine the resource location of the SCI transmitted in the first to eighth rounds by the resource determination method described in the “Case in which K is even number” and the resource location of SCI additionally transmitted one time may be the resource location of SCI transmitted in the seventh rounds.

As another method, the user equipment UE may use any one of the resource locations determined using the same method as the resource determination method described in the “Case in which K is even number” as the resource location of SCI additionally transmitted one time. For example, when SCI is repeatedly transmitted seven times, the user equipment UE may determine the resource locations of SCI transmitted in the first to eighth rounds by the resource determination method described in the “Case in which K is even number,” and any one of the resource locations of SCI transmitted in the seventh and eighth rounds may be used as the resource location of the SCI additionally transmitted one time. Moreover, the user equipment UE may determine which resource location is to be selected using the SA ID. For example, the user equipment UE may select the last odd-numbered resource location when the last bit of the SA ID is “0,” and may select the last even-numbered resource location when the last bit of the SA ID is “1”. In this way, the resource location of SCI additionally transmitted one time is distributed to respective user equipments UEs.

Hereinabove, the “first SCI repeat transmission method” has been described. According to the “first SCI repeat transmission method,” since the subframes in which SCI is transmitted can be distributed to a plurality of user equipments UEs, it is possible to perform control so that the occurrence of a problem (a half-duplex problem) that two user equipments UEs transmit SCI in the same subframe and one user equipment UE cannot receive SCI transmitted by the other user equipment UE is prevented as much as possible.

<Second SCI Repeat Transmission Method>

Next, a second SCI repeat transmission method will be described. Hereinafter, a case in which the user equipment UE repeatedly transmits SCI two times and a case in which SIC is repeatedly transmitted three or more times will be described. The number of times the user equipment UE repeatedly transmits SCI may be notified from the base station eNB to the user equipment UE using notification information (SIB) or RRC signaling and may be pre-configured in the user equipment UE by a SIM, a core network, or the like. Moreover, a different number of times may be designated to each user equipment UE and a different number of times may be designated to each cell or each SCI resource pool.

(Case in which SCI is Repeatedly Transmitted Two Times)

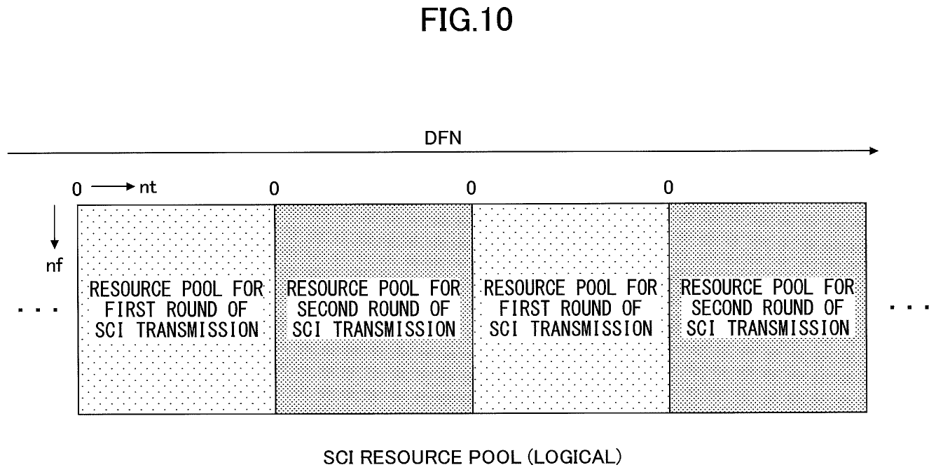

In the second SCI repeat transmission method, as illustrated in FIG. 10, a SCI resource pool is divided into two regions which repeatedly appear at the same interval. The first region corresponds to a resource pool for transmitting SCI in the first round (the first SCI transmission resource pool in FIG. 10), and the second region corresponds to a resource pool for transmitting SCI in the second round (the second SCI transmission resource pool in FIG. 10). The user equipment UE selects a resource from the first SCI transmission resource pool and transmits the SCI when the SCI is transmitted in the first round and selects a resource from the second SCI transmission resource pool and transmits the SCI when the SCI is transmitted in the second round.

FIG. 10 logically illustrates the SCI resource pool similarly to FIGS. 9A and 9B. That is, in a physical expression, the resources in the “nf” direction in FIG. 10 sequentially correspond to four resources present in the upper and lower-side SCI resource pools in FIG. 8. The resource indicated by “nf=0” in FIG. 10 may correspond to the uppermost resource (the resource on the uppermost layer in FIG. 8) in the frequency direction of FIG. 8, and conversely, may correspond to the lowermost resource (the resource on the lowermost layer in FIG. 8) in the frequency direction of FIG. 10. Moreover, “nt” means the location of a subframe, and “nf” means the location of a resource block in the frequency direction. The “nt” is not intended to indicate a specific subframe number but is a variable indicating the relative location of a subframe. Similarly, the “nf” is a variable indicating the relative location of the resource block in the frequency direction.

In the second SCI repeat transmission method, the resource location of SCI transmitted in the second round may be determined according to Equation 5 below. “Nt” means the number of subframes present in the first SCI transmission resource pool and the second SCI transmission resource pool.

(Equation 5)

next_nt=mod(c*nf+nt*Nf+a,Nt)

next_nf=mod(floor((nf+nt*Nf)/Nt)+b,Nf)

a,b,c are predetermined constants [Math 5]

Here, “a,” “b,” and “c” are predetermined integers.

In the second SCI repeat transmission method, the interval between the first SCI transmission resource pool and the second SCI transmission resource pool may be notified from the base station eNB to the user equipment UE using notification information (SIB) or RRC signaling and may be pre-configured in the user equipment UE by a SIM, a core network, or the like.

(Case in which SCI is Repeatedly Transmitted Three or More Times)

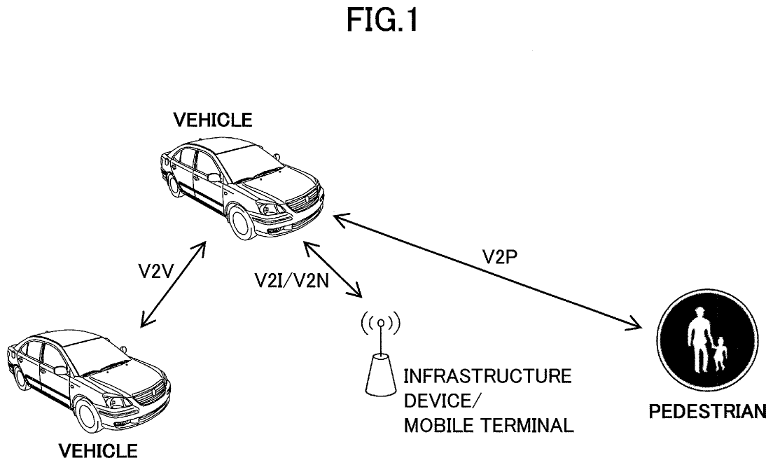

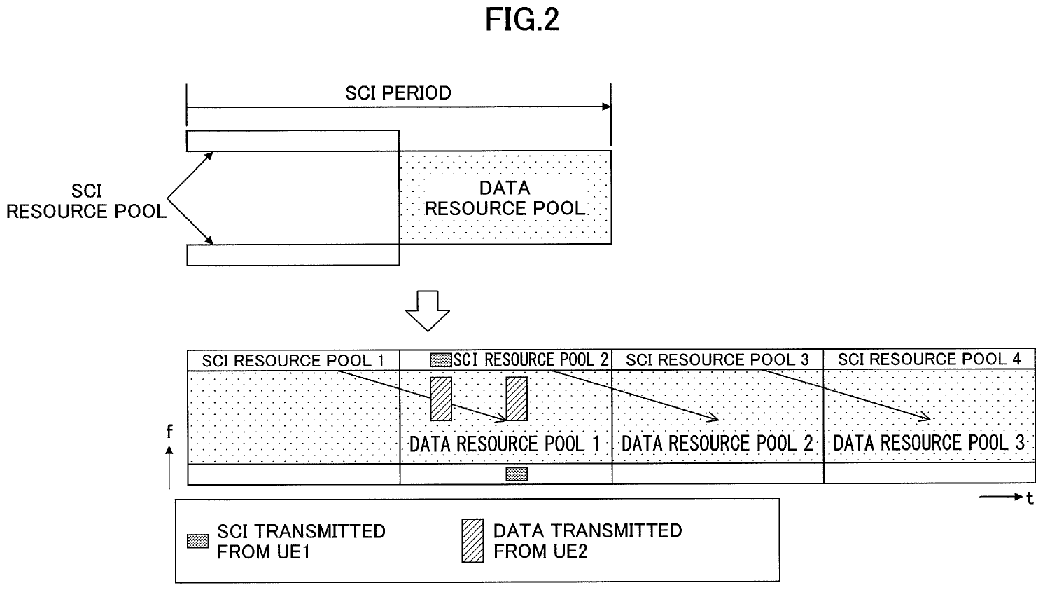

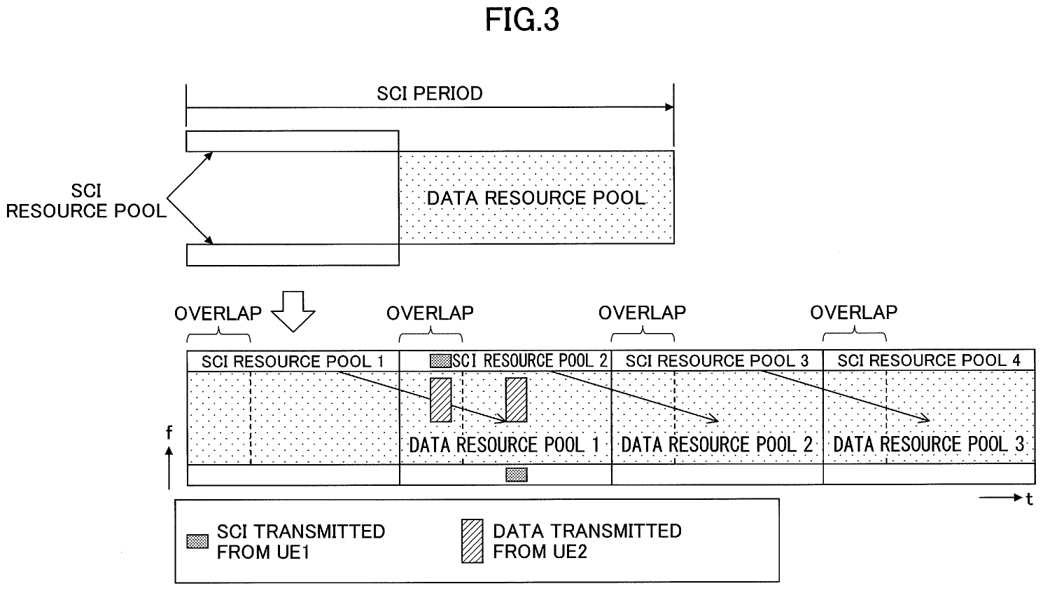

Next, a resource determination method when SCI is repeatedly transmitted three or more times will be described. When SIC is repeatedly transmitted three or more times, as illustrated in FIG. 1, the SCI resource pool may be divided into K regions which repeatedly appear at the same interval, and the user equipment UE may select resources from the first to K-th SCI transmission resource pools and transmit the SCI when SCI is transmitted in the first to K-th rounds. Moreover, the user equipment UE may determine the resources to be selected using Equation 5 described above.

As another method, the user equipment UE may repeatedly perform a resource selection method determined according to a predetermined resource determination method “K/2” times. Moreover, when K is an odd number, the user equipment UE may determine the resource location of SCI additionally transmitted one time using the SA ID or randomly. For example, the user equipment UE may select the first resource location among the resource locations determined by a predetermined resource determination method when the last bit of the SA ID is “0” and may select the second resource location among the resource locations determined by a predetermined resource determination method when the last bit of the SA ID is “1”. In this way, the resource location of SCI additionally transmitted one time is distributed to respective user equipments UEs.

Hereinabove, the “second SCI repeat transmission method” has been described. According to the “second SCI repeat transmission method,” since the subframes in which SCI is transmitted can be distributed to a plurality of user equipments UEs, it is possible to perform control so that the occurrence of a problem (a half-duplex problem) that two user equipments UEs transmit SCI in the same subframe and one user equipment UE cannot receive SCI transmitted by the other user equipment UE is prevented as much as possible.

<Data Repeat Transmission Method>

Next, a method of determining the location of a resource for transmitting each item of data when a user equipment UE repeatedly transmits data will be described. As described above, since the D2D employs a half-duplex communication method, the user equipment UE cannot receive and receive a D2D signal simultaneously in the same subframe. Therefore, in the present embodiment, the user equipment UE selects a resource for data transmission from a data resource pool so that a subframe interval between items of repeatedly transmitted data is longer than a largest value of the subframe intervals between items of repeatedly transmitted SCI and transmits data.

In the present embodiment, the number of times data is repeatedly transmitted may be fixedly defined in advance by standard specifications or the like and may be dynamically changed by inserting the number of times data is repeatedly transmitted in a setting value of SCI.

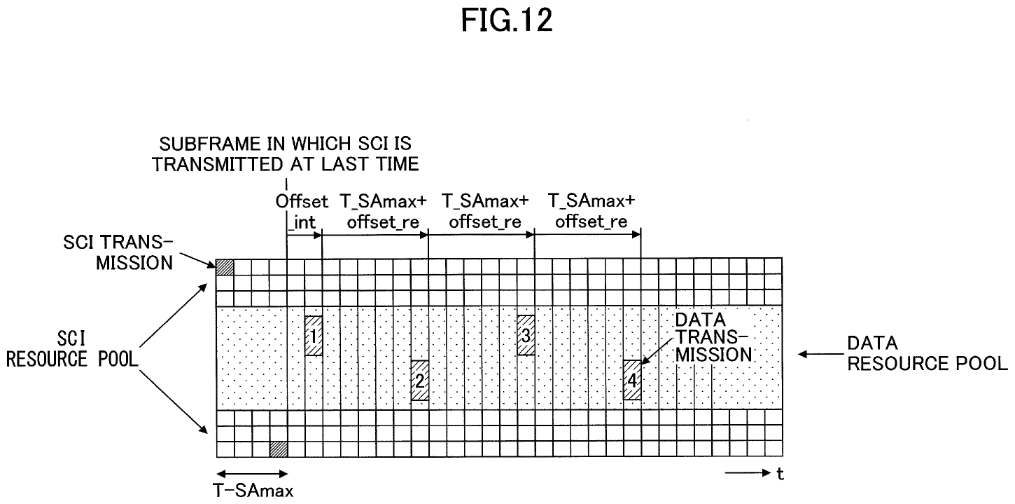

FIG. 12 is a diagram for describing a data repeat transmission method. In the present embodiment, a predetermined offset value indicating the interval between a subframe in which SCI is transmitted at the last time and a subframe in which data corresponding to the SCI is transmitted at the first time is defined as “offset_ini”. The “offset_ini” is an arbitrary value between “l” and “T_SAmax” and is arbitrarily determined by a transmission-side user equipment UE. Here, the “T-SAmax” is calculated by “T-SAmax=floor(Nf/2)+1” when the “first SCI repeat transmission method” is used. Moreover, the T-SAmax is calculated by “T-SAmax=(number of subframes in a resource pool for transmitting first item of SCI) 4 (number of subframes in a resource pool for transmitting second item of SCI)” when the “second SCI repeat transmission method” is used.

The “offset_ini” may be a time offset value from the subframe in which SCI is transmitted at the first time. Moreover, SCI and data may be configured to be transmitted in the same subframe by setting the “offset_ini” to 0.

It is possible to allow a reception-side user equipment UE to recognize that SCI and data are transmitted in the same subframe using the flag in SCI or the format of SCI rather than using the “offset_ini”. A transmission-side user equipment UE may autonomously select a transmission method of transmitting SCI and data in the same subframe or different subframes, and a selectable transmission method may be limited according to the performance of the user equipment UE. The performance of the user equipment UE may be reported to the bending direction so that an appropriate transmission method can be designated when the base station eNB allocates resources. Moreover, the user equipment UE may switch the transmission method according to transmission power, which will be described later.

As for the transmission power levels of SCI and data, a set transmission power level (for example, a total transmission power level, a transmission power level density, a target reception power level in Fractional TPC, a propagation loss compensation term, and the like) is used when SCI and data are transmitted in different subframes, and different transmission power levels may be set when SCI and data are transmitted in the same subframe (including a case in which subframes overlap partially). For example, when the transmission power level of SCI and data is set to 23 dBm, data cannot be transmitted if SCI transmission is prioritized in simultaneous transmission and a sufficient SCI quality may not be guaranteed if a power level density is evenly distributed. Such a problem can be avoided by setting the power level independently.

Specifically, when the transmission power level exceeds the largest transmission power level due to simultaneous transmission, the user equipment UE may adjust the transmission power level so as to satisfy the largest transmission power level using any one of the following methods or a combination thereof or may transmit SCI and data in different subframes without performing simultaneous transmission. (1) A transmission power level offset is set between SCI and data. For example, the transmission power level is controlled so that the transmission power level (density) of data is 3 dB higher than that of SCI. (2) The lowest transmission power level (density) of SCI and data is set (the same may be set for SCI only). (3) A largest transmission bandwidth of data is set.

In the present embodiment, the predetermined offset value to be used for calculating the interval of subframes when data is repeatedly transmitted is defined as “offset_re”. The “offset_re” is an arbitrary number between “0” and “T_SAmax−1”. The “offset_re” is arbitrarily determined by a transmission-side user equipment UE.

As illustrated in FIG. 12, the user equipment UE transmits the first item of data in a subframe which is “offset_ini” later than the subframe in which SCI was transmitted at the last time. After that, data is repeatedly transmitted so that the subframe interval between respective items of data is “T_samax+offset_re”. A subframe location in which a user equipment UE transmits data in the n-th round is expressed by an equation “(Subframe location in which data is transmitted in the n-th round)=(Subframe location in which SCI is transmitted in the last round)+(n−1)×(T-SA_max+offset_re)+offset_ini”.

In the example of FIG. 12, since Nf=6, T-SA_max=4. In this case, the user equipment UE selects an arbitrary value from 1 to 6 as the value of “offset_ini” and selects an arbitrary value from 0 to 5 as the value of “offset_re”. The example of FIG. 12 illustrates a case in which “2” is selected as the values of “offset_ini” and “offset_re”.

In the present embodiment, a resource (a resource block) in the frequency direction in which data is transmitted may be selected arbitrarily. For example, the resources in the frequency direction of the respective items of repeatedly transmitted data may be arbitrarily determined by the user equipment UE and may be instructed to the user equipment UE from the base station eNB. As another example, the resources in the frequency direction when data is transmitted in the first round only may be arbitrarily determined by the user equipment UE (or may be instructed to the user equipment UE from the base station eNB), and the data repeatedly transmitted thereafter may be transmitted using the resource in the frequency direction determined based on a predetermined hopping pattern. The predetermined hopping pattern may be an arbitrary pattern and may be a hopping pattern set such that a resource location in the frequency direction in which data is transmitted is distributed to a plurality of subbands defined in a data resource pool like PSSCH in the conventional LTE, for example.

Hereinabove, the data repeat transmission method has been described. According to the present embodiment, a subframe interval in which SCI is repeatedly transmitted is different from a subframe interval in which data is repeatedly transmitted. Due to this, it is possible to perform control so that the occurrence of a problem (a half-duplex problem) that the user equipment UE that transmits SCI and the user equipment UE that transmits data transmit a D2D signal in the same subframe and one user equipment UE cannot receive the D2D signal transmitted by the other user equipment UE is prevented as much as possible.

<SCI Setting Value>

Next, the setting value stored in SCI in the present embodiment will be described in detail. The values of “offset_ini” and “offset_re” which are parameters for calculating the subframe location when data corresponding to SCI is repeatedly transmitted are stored in the SCI. The value of “T_SAmax” may be stored in the SCI or may not be stored. The “T_SAmax” may be omitted since the user equipment UE can calculate the same by itself using the value of “Nf” determined based on the setting of a SCI resource pool.

Moreover, SCI includes information indicating the resource locations in the frequency direction when respective items of data are transmitted. The information indicating the resource locations in the frequency direction when respective items of data are transmitted may include all resource locations in the frequency direction corresponding to the number of repetitions, and the resource in the frequency direction when data is transmitted in the first round and information indicating a predetermined hopping pattern may be stored in the information.

The values of “offset_ini” and “offset_re” may be stored in an area for storing a T-RPT pattern bit in the format of SCI in the conventional D2D. In the present embodiment, since the data transmission method is different from that of the conventional D2D, it is possible to use an area for storing the T-RPT pattern bit. Moreover, the value of “offset_re” may be set to the last three or four bits of the SA ID stored in the SCI.

By allowing “offset_re” to be calculated according to a predetermined equation, “offset_re” may not be stored in the SC. For example, the maximum value of “offset_re” may be defined as “max_offset_re” and “offset_re” may be calculated by an equation “offset_re=mod(nf,max_offset_re+1)”. Here, “nf” means a resource block location in the frequency direction in a data resource pool, in which respective items of data are transmitted. That is, when the resources in the frequency direction in which respective items of data are transmitted change, the equation is used whereby a data transmission interval is controlled to change. The “max_offset_re” may be notified from the base station eNB to the user equipment UE using notification information (SIB) or RRC signaling and may be pre-configured in the user equipment UE by a SIM, a core network, or the like. In this way, the data amount of SCI can be reduced.

Beside this, information that designates MCS (Modulation and Coding Scheme) or TA (Timing Alignment) may be included in the SCI. Moreover, new SCI may be defined to implement the present embodiment.

When resources are allocated from the base station eNB, the resource allocation signaling transmitted from the base station eNB to the user equipment E may include the setting value stored in the SCI and information or the like that specifies a predetermined hopping pattern.

As described above, the number of times data is repeatedly transmitted may be included in the SCI.

<Supplementary Explanation of Data Repeat Transmission Method>

As described above, a predetermined offset value “offset_ini” indicating the interval between a subframe in which SCI is transmitted at the last time and a subframe in which data corresponding to the SCI is transmitted at the first time is stored in the SCI. However, it cannot be said that the reception-side user equipment UE can receive the SCI transmitted at the last time among the items of repeatedly transmitted SCI. In this case, there is a possibility that the reception-side user equipment UE cannot correctly recognize the resource location in which data corresponding to the received SCI is transmitted at the first time. For example, when SCI is repeatedly transmitted two times and a reception-side user equipment UE receives the SCI transmitted in the first round, there is a possibility that the reception-side user equipment UE specifies the location of the subframe in which data is transmitted based on the subframe of the SCI received in the first round.

Therefore, when SCI is repeatedly transmitted two times according to the first SCI repeat transmission method, the reception-side user equipment UE may determine whether the received SCI is the SCI transmitted in the first round or the SCI transmitted in the second round based on the resource location in the frequency direction of the received SCI (that is, based on where the resource is located in the upper-side SCI resource pool in FIG. 8 or the lower-side SCI resource pool). Due to this, when it is determined that the received SCI is the SCI transmitted in the first round, the reception-side user equipment UE can estimate the subframe location of the SCI transmitted in the second round using Equation 1 or 2 described above and specify the location of the subframe in which data is transmitted based on the estimated subframe location.

When SCI is repeatedly transmitted three or more times according to the first SCI repeat transmission method, the resources in the frequency direction in the SCI resource pool may be divided by the number of times SCI is repeatedly transmitted and the respective items of repeatedly transmitted SCI may be transmitted using the divided frequency resources. For example, if the resources (the number of “Nf”) in the frequency direction in the SCI resource pool are set as the number of times SCI is repeatedly transmitted, it is possible to evenly divide frequency resources by the number of times SCI is repeatedly transmitted and to secure the same number of transmission resource candidates for respective repeated SCI transmissions. Alternatively, the resource interval in the time direction between items of repeatedly transmitted SCI may be semistatically fixed in advance. A resource in the frequency direction in which SCI is transmitted may be shared in advance between the transmission-side user equipment UE and the reception-side user equipment UE for each item of repeatedly transmitted SCI. In this way, the reception-side user equipment UE can determine the round in which the received SCI is transmitted based on the resource location in the frequency direction of the received SCI. Moreover, the user equipment UE can estimate the subframe location of the SCI transmitted at the last time based on the determination result and specify the location of the subframe in which data is transmitted based on the estimated subframe location.

As an example of correspondence between the SCI repeatedly transmitted and the resource in the frequency direction, the SCI transmitted in the first round may be transmitted using the resource on the uppermost layer in FIG. 8, the SCI transmitted in the second round may be transmitted using the resource on the lowermost layer in FIG. 8, the SCI transmitted in the third round may be transmitted using the resource one layer below the uppermost layer in FIG. 8, and the SCI transmitted in the fourth round may be transmitted using the resource one layer above the lowermost layer in FIG. 8.

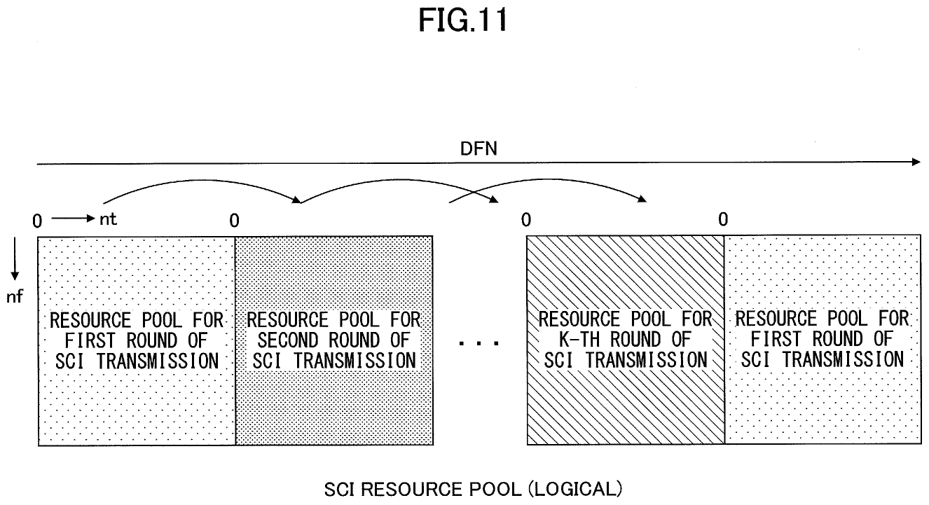

When SCI is repeatedly transmitted according to the second SCI repeat transmission method, information (a calculation formula or the like) for specifying an absolute location (for example, DFN and a subframe) of time resources of a starting point and an ending point of a SCI transmission resource pool (in the example of FIG. 11, each of the first to K-th SCI transmission resource pools) for each transmission round may be notified in advance from the base station eNB to the user equipment UE using notification information (SIB) or RFC signaling and may be pre-configured in the user equipment UE by a SIM, a core network, or the like. Due to this, the reception-side user equipment UE can determine the round in which the received SCI is transmitted by specifying the SCI transmission resource pool to which the DFN and the subframe number of the received SCI correspond. Moreover, the user equipment UE can estimate the subframe location of the SCI transmitted at the last time using Equation 5 described above, for example, and specify the location of the subframe in which data is transmitted based on the estimated subframe location.

As another method, the transmission-side user equipment UE may insert information indicating the number of transmissions in the SCI. In this way, the reception-side user equipment UE can easily specify the round in which the received SCI is transmitted.

As still another method, the value of “offset_ini” may indicate the interval between the subframe in which SCI is actually transmitted and the subframe in which data corresponding to the SCI is transmitted at the first time. That is, the value of “offset_ini” may be changed according to the number of SCI transmissions. In this way, the reception-side user equipment UE can detect the subframe in which data is transmitted at the first time without specifying the round in which the received SCI is transmitted. The value of “offset_ini” may indicate the absolute location (a DN and a subframe number) of the time resource in which data is transmitted at the first time.

<Avoidance of Collision Between SCI and Data>

V2X considers a scenario in which a number of user equipments UEs transmit a D2D signal in the same resource pool. Therefore, there is a possibility that a plurality of user equipments UEs selects the same resource to transmit SCI and data and collision of SCI and data may occur. On the other hand, since V2X considers an operation form in which a V2X packet is transmitted every 10 ms, for example, it is expected that a user equipment UE can predict data to be transmitted in the future to some extent.

Therefore, in the present embodiment, in order to avoid collision of SCI and data transmitted from a plurality of user equipments UEs, the user equipment UE may insert an identifier indicating the location of a resource scheduled to transmit new SCI and data to SCI to thereby notify another user equipment UE of the fact that the new SCI and data is scheduled to be transmitted using the resource (the resource is reserved).

<SCI Transmission Resource Reservation Method>

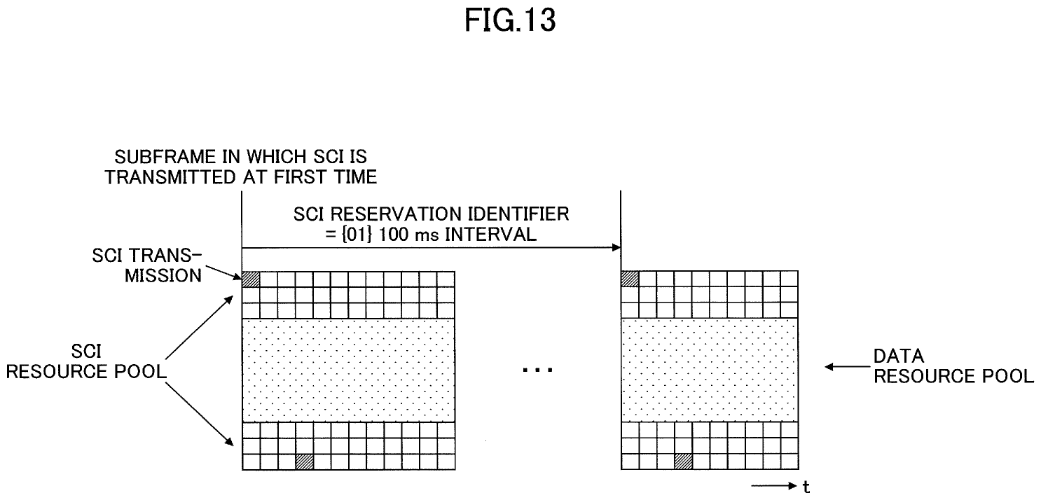

FIG. 13 is a diagram for describing a SCI transmission resource reservation method. When a user equipment UE is scheduled to transmit new SCI in order to transmit data (V2X packet) after the elapse of a predetermined period (after a predetermined subframe), the user equipment UE transmits the data by inserting an identifier (hereinafter referred to as a “SCI reservation identifier”) indicating reservation of a resource for transmitting the new SCI after the elapse of a predetermined period (after a predetermined subframe) in the SCI.

A specific transmission interval (for example, 100 ms or the like) between SCI (the SCI in which the SCI reservation identifier is included) scheduled to be transmitted most recently and new SCI scheduled to be transmitted after the elapse of a predetermined period may be set in the SCI reservation identifier, and a bit value (for example, a two-bit value) for expressing the transmission interval by a predetermined number of units (for example, one unit corresponds to 100 ms) may be set in the SCI reservation identifier. In the latter case, for example, “00” means that no resource is reserved, “01” means that the transmission interval is one unit (for example, 100 ms), “10” means that the transmission interval is two units (for example, 200 ms), and “11” means that the transmission interval is four units (for example, 400 ms). Moreover, the transmission interval meant by a predetermined one unit may be notified from the base station eNB to the user equipment UE using notification information (SIB) or RRC signaling and may be pre-configured in the user equipment UE by a SIM, a core network, or the like.

The example of FIG. 13 illustrates a case in which a resource after the elapse of 100 ms is reserved as a resource scheduled to transmit new SCI. As described above, in the present embodiment, the same SCI is repeatedly transmitted a plurality of number of times. Due to this, a user equipment UE having transmitted the SCI that includes the SCI reservation identifier operates to recognize that the new SCI is repeatedly transmitted in the resource designated by the SCI reservation identifier at the same transmission interval and the same resource location in the frequency direction as the SCI that includes the SCI reservation identifier. That is, as illustrated in the example of FIG. 13, when the SCI that includes the SCI reservation identifier is repeatedly transmitted two times, the user equipment UE operates to recognize that the new SCI is repeatedly transmitted two times after the elapse of 100 ms at the same transmission interval and the same resource location in the frequency direction as the SCI that includes the SCI reservation identifier.

<Data Transmission Resource Reservation Method>

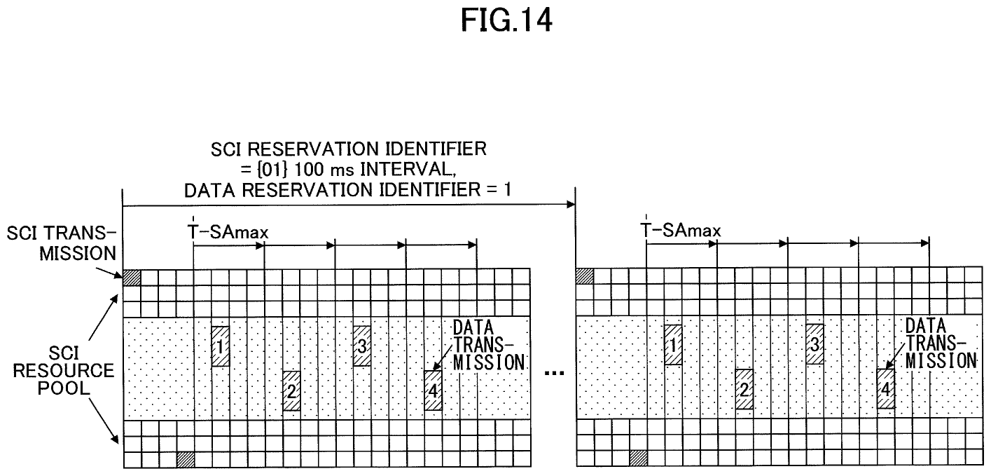

FIG. 14 is a diagram for describing a data transmission resource reservation method. When a user equipment UE is scheduled to transmit new data (a V2X packet) after the elapse of a predetermined period (after a predetermined subframe), the user equipment UE transmits the data by inserting an identifier (hereinafter referred to as a “data reservation identifier”) indicating reservation of a resource for transmitting the new data after the elapse of a predetermined period (after a predetermined subframe) in the SCI.

Information indicating whether a resource for transmitting new data is reserved after the elapse of a predetermined period indicating the SCI reservation identifier is stored in the data reservation identifier. That is, when a user equipment UE reserves a resource that transmits data, the user equipment UE needs to insert both the SCI reservation identifier and the data reservation identifier in the SCI. The information may be expressed by one bit, for example. More specifically, “0” may mean that no resource is reserved and “1” may mean that a resource is reserved after the elapse of a predetermined period indicated by the SCI reservation identifier.

The example of FIG. 14 illustrates a case in which a resource after the elapse of 100 ms is reserved as a resource scheduled to transmit new data. As described above, in the present embodiment, the same data is repeatedly transmitted a plurality of number of times. Due to this, a user equipment UE having received the SCI that includes the data reservation identifier operates to recognize that new data is repeatedly transmitted in the resource after the elapse of the predetermined period indicated by the SCI reservation identifier at the same transmission interval and the same resource location in the frequency direction as the data corresponding to the SCI. That is, as illustrated in the example of FIG. 14, when data (the data on the left side of FIG. 14) corresponding to the SCI that includes the data reservation identifier is repeatedly transmitted four times, the user equipment UE operates to recognize that new data (the data on the right side of FIG. 14) is also repeatedly transmitted four times at the same transmission interval and the same resource location in the frequency direction as the data (the data on the left side of FIG. 14) corresponding to the SCI that includes the data reservation identifier.

<Operation Example Using SCI and Data Transmission Resource Reservation>

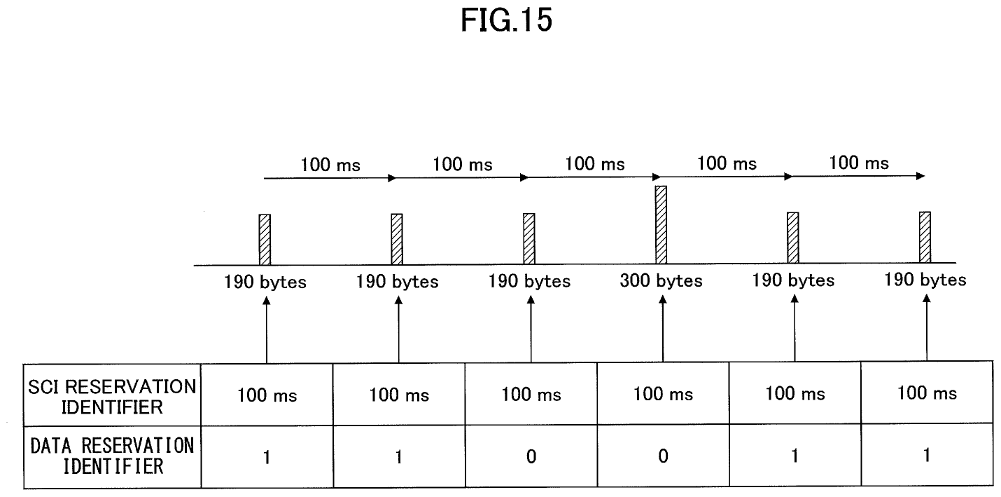

FIG. 15 is a diagram illustrating a first specific example of a reservation method for reserving resources for transmitting SA and data. FIG. 15 illustrates a state in which a user equipment UE transmits a 190-byte or 300-byte V2X packet at an interval of 100 ms. However, more specifically, when one V2X packet is transmitted, a plurality of same items of SCI and a plurality of same items of data (MAC PDU in which one V2X packet is stored) are repeatedly transmitted. In other words, more specifically, transmission of one V2X packet illustrated in FIG. 15 corresponds to a series of SCI and data transmissions illustrated in FIG. 12 is performed one time.

Here, it is assumed that a user equipment UE is scheduled to transmit a 190-byte or 300-byte V2X packet at an interval of 100 ms. When the size of data scheduled to be transmitted most recently is the same as the size of data scheduled to be transmitted after the elapse of 100 ms, the user equipment UE transmits both the SCI reservation identifier and the data reservation identifier by inserting the same in the SCI scheduled to be transmitted most recently. The example of FIG. 15 illustrates a case in which, when the size of data scheduled to be transmitted most recently and the size of data scheduled to be transmitted after the elapse of 100 ms is 190 bytes, the user equipment UE sets a bit value indicating 100 is to the SCI reservation identifier, sets a bit (“1”) indicating that data reservation is to be performed to the data reservation identifier, and transmits SCI.

On the other hand, when the size of data scheduled to be transmitted most recently is different from the size of data scheduled to be transmitted after the elapse of 100 ms, the user equipment UE transmits the SCI reservation identifier only by inserting the same in the SCI scheduled to be transmitted most recently. Moreover, the user equipment UE allocates the data transmission resources using the SCI to be transmitted after the elapse of 100 ms (that is, resources are allocated at the time point at which data is transmitted without reserving data transmission resources). This is because, in the present embodiment, since the data transmission resource to be reserved has the same size (for example, the same number of resource block pairs) as the data scheduled to be transmitted most recently, when the data size is different from the size of data scheduled to be transmitted after the elapse of 100 ms, it may be difficult to store the data scheduled to be transmitted in the reserved resource size. The example of FIG. 15 illustrates a case in which, when the size of data scheduled to be transmitted most recently and the size of data scheduled to be transmitted after the elapse of 100 ms are 190 bytes and 300 bytes (or 300 bytes and 190 bytes), respectively, the user equipment UE transmits SCI by storing a bit value indicating 100 ms in the SCI reservation identifier and a bit (“0”) indicating that data reservation is not to be performed in the data reservation identifier.

A physical layer of the user equipment UE may detect whether the size of a V2X packet scheduled to be transmitted at a subsequent timing is the same as the size of a V2X packet scheduled to be transmitted most recently based on a notification from a higher layer (for example, Layer 2, an application layer, or the like) of the user equipment UE. Similarly, the physical layer of the user equipment UE may detect the transmission interval between the V2X packet scheduled to be transmitted most recently and the V2X packet scheduled to be transmitted at the subsequent timing based on a notification from a higher layer (for example, Layer 2, an application layer, or the like) of the user equipment UE. In this way, the physical layer of the user equipment UE can determine a value to be set to the SCI reservation identifier and a value to be set to the data reservation identifier in the process of generating SCI to be transmitted most recently based on a notification from the higher layer.

<Modification of Data Transmission Resource Reservation Method and Operation Example>

As a modification of the data transmission resource reservation method, information (for example, 2 bits) indicating whether resources in both the time direction and the frequency direction are to be reserved or the resources (that is, the subframes) in the time direction only are to be reserved may be set to the data reservation identifier in addition to the information indicating whether resources are reserved. For example, “00” means that no resource is reserved, “01” may mean that resources in both the time direction and the frequency direction are reserved, and “10” may mean that the resources in the time direction only are reserved.

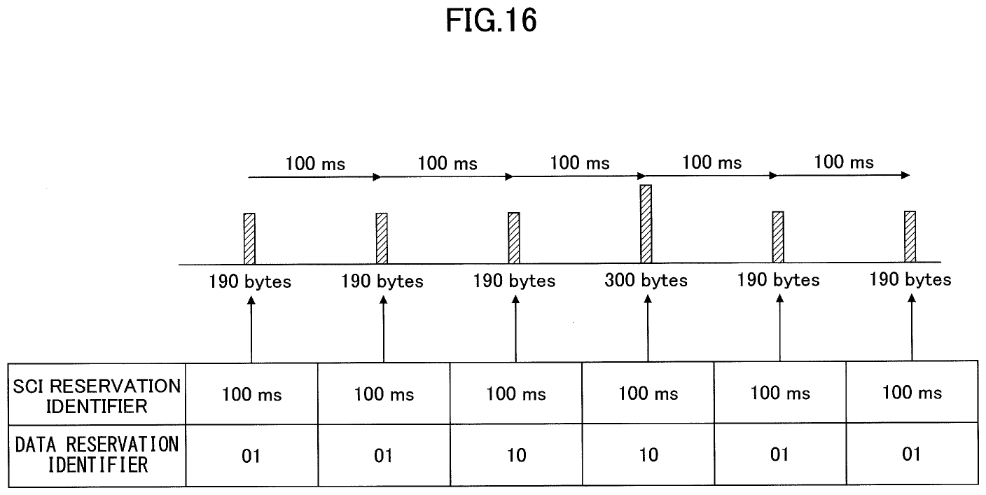

FIG. 16 is a diagram illustrating a second specific example of a reservation method for reserving resources for transmitting SA and data. The other features which are not mentioned particularly may be the same as those of FIG. 15.

When the size of data scheduled to be transmitted most recently is the same as the size of data scheduled to be transmitted after the elapse of 100 ms, the user equipment UE transmits a data reservation identifier indicating that the resources in both the time direction and the frequency direction are to be reserved by inserting the same in the SCI scheduled to be transmitted most recently. The example of FIG. 16 illustrates a case in which, when the size of data scheduled to be transmitted most recently and the size of data scheduled to be transmitted after the elapse of 100 ms is 190 bytes, the user equipment UE stores a bit value indicating 100 ms in the SCI reservation identifier, stores a bit (“01”) indicating that the resources in both the time direction and the frequency direction are to be reserved in the data reservation identifier, and transmits SCI.

On the other hand, when the size of data scheduled to be transmitted most recently is different from the size of data scheduled to be transmitted after the elapse of 100 ms, the user equipment UE may transmit the SCI reservation identifier and the data reservation identifier indicating that the resources in the time direction only are to be reserved by inserting the same in the SCI scheduled to be transmitted and may allocate the resources in the frequency direction for data transmission using the SCI to be transmitted after the elapse of 100 ms. The example of FIG. 16 illustrates a case in which, when the size of data scheduled to be transmitted most recently and the size of data scheduled to be transmitted after the elapse of 100 ms are 190 bytes and 300 bytes (or 300 bytes and 190 bytes), respectively, the user equipment UE stores a bit value indicating 100 ms in the SCI reservation identifier, stores a bit (“10”) indicating the resources in the time direction only are to be reserved in the data reservation identifier, and transmits SCI.

In this way, even when the size of data scheduled to be transmitted most recently is different from the size of data scheduled to be transmitted subsequently, the user equipment UE can notify the other user equipment UE of the fact that the D2D signal is scheduled to be transmitted using any of the frequency resources in the subframe after the elapse of a predetermined period.

<Operation of User Equipment Scheduled to Transmit SCI and Data>

When the largest period that can be designated to the SCI reservation identifier is 400 ms, there is a possibility that a resource with which another user equipment UE transmits SCI (or SCI and data) is already reserved in a period between the current time point and the time point after the elapse of 400 ms. Therefore, the user equipment UE may monitor SCI that other user equipments UEs transmit in the largest period (a period in which transmission of SCI is likely to be reserved) that can be designated to the SCI reservation identifier before transmitting SCI, select a resource which is not reserved among the resources after the elapse of the period, and start transmitting SCI (or SCI and data). In this way, it is possible to avoid the user equipment UE from transmitting SCI (or SCI and data) using a resource which has already been reserved.

As another method, the user equipment UE may monitor whether another user equipment UE transmits SCI in a subframe other than the subframe in which the user equipment UE itself transmits SCI while transmitting SCI and may stop subsequent transmission of SCI in order to avoid collision when the SCI from the other user equipment UE is detected.

Moreover, when the result of monitoring of the SCI that the other user equipment UE transmits in the largest period (the period in which transmission of SCI is likely to be reserved) that can be designated to the SCI reservation identifier shows that transmission of SCI is reserved (that is, when SCI including the SCI reservation identifier is detected), the user equipment UE may stop transmission of SCI rather than transmitting SCI by selecting a non-reserved resource.

Moreover, when the result of monitoring of the SCI that the other user equipment UE transmits in the largest period (the period in which transmission of SCI is likely to be reserved) that can be designated to the SCI reservation identifier shows that transmission of SCI and data is reserved (that is, when SCI including the SCI reservation identifier and the data reservation identifier is detected), the user equipment UE may notify the other user equipment UE of the fact that resources are reserved by selecting a non-reserved resource and transmitting the SCI that includes the SCI reservation identifier only and transmit SCI and data using the resource reserved by the SCI reservation identifier. In this way, it is possible to avoid collision of SCI and data more reliably,

<Functional Configuration>

A functional configuration example of the user equipment UE and the base station eNB that execute the operation of the plurality of embodiments described above will be described.

(User Equipment)

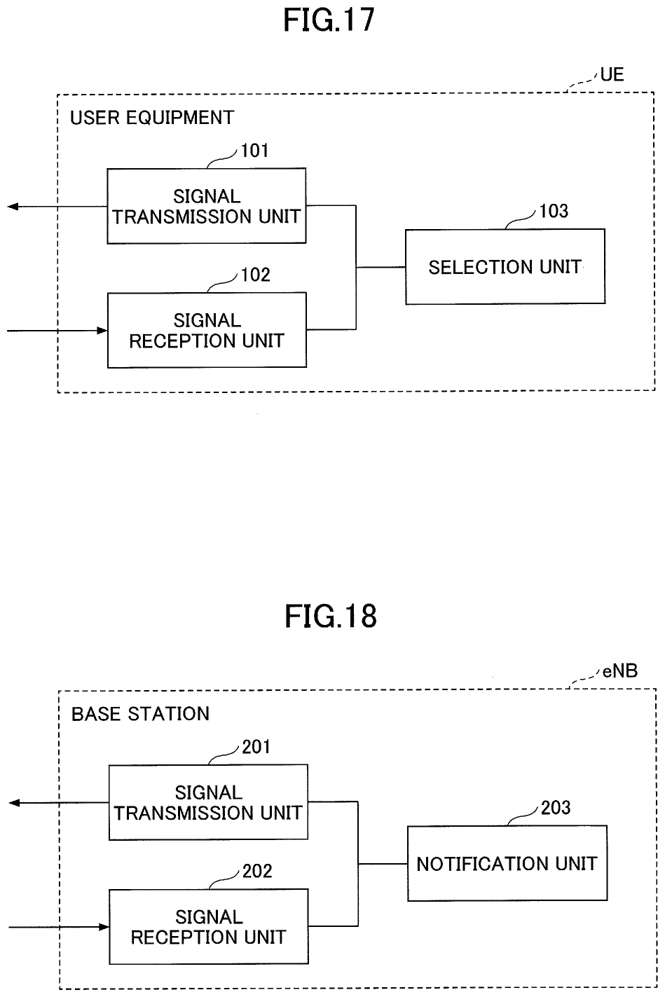

FIG. 17 is a diagram illustrating an example of a functional configuration of a user equipment according to the embodiment. As illustrated in FIG. 17, the user equipment UE includes a signal transmission unit 101, a signal reception unit 102, and a selection unit 103. FIG. 17 illustrates functional units of the user equipment UE particularly related to the embodiment only and also includes at least functions (not illustrated) for performing operations compatible with LTE. Moreover, the functional configurations illustrated in FIG. 17 are examples only. The functional classifications and the names of the functional units are not particularly limited as long as the operations according to the present embodiment can be executed.

The signal transmission unit 101 includes a function of generating various signals of the physical layer from higher-layer signals to be transmitted from the user equipment UE and transmitting the signals wirelessly. Moreover, the signal transmission unit 101 has a D2D signal transmission function and a cellular communication transmission function. Furthermore, the signal transmission unit 101 has a function of transmitting the D2D signal using a resource selected by the selection unit 103. Furthermore, the signal transmission unit 101 may transmit the SCI reservation identifier (or the SCI reservation identifier and the data reservation identifier) by inserting the same in SCI.

The signal reception unit 102 includes a function of wirelessly receiving various signals from the other user equipment UE or the base station eNB and acquiring higher-layer signals from the received physical layer signals. Moreover, the signal reception unit 102 has a D2D signal receiving function and a cellular communication receiving function.

The selection unit 103 has a function of selecting a first control information resource for transmitting control information (SCI) from a SCI resource pool and selecting a first data resource for transmitting data from a data resource pool. More specifically, the selection unit 103 has a function of selecting a first control information resource for transmitting control information (SCI) from a SCI resource pool and selecting a first data resource for transmitting data from a data resource pool among radio resources in which the SCI resource pool and a data resource pool are continuously set without any limitation in the time direction.

When the SCI resource pool is divided into a first SCI resource pool (the SCI resource pool on the upper side of FIG. 7) set in a higher frequency band than the frequency band of the data resource pool and a second SCI resource pool (the SCI resource pool on the lower side of FIG. 7) set in a lower frequency band than the frequency band of the data resource pool, the selection unit 103 may select the first control information resource from the first SCI resource pool or the second data resource pool. When the first control information resource is selected from the first SCI resource pool, the selection unit 103 may select the second control information resource from the second SCI resource pool in a subframe later than the subframe of the first control information resource. When the first control information resource is selected from the second SCI resource pool, the selection unit 103 may select the second control information resource from the first SCI resource pool in a subframe later than the subframe of the first control information resource.

The selection unit 103 may determine a subframe in which the second control information resource is selected based on a resource location in the frequency direction of the first control information resource. Moreover, the selection unit 103 may insert the second control information resource in a time region different from a time region in which the first control information resource is inserted among the time regions (the first SCI transmission resource pool and the second SCI transmission resource pool in FIG. 10) in which the first SCI resource pool and the second SCI resource pool are repeatedly set.

The selection unit 103 may select the second data resource from the data resource pool in a subframe later than the subframe of the first data resource. Moreover, the selection unit 103 may select the second data resource so that the interval between a subframe in which the first data resource is selected and a subframe in which the second data resource is selected is larger than a subframe interval between a subframe in which the first control information resource is selected and a subframe in which the second control information resource is selected.

(Base Station)

FIG. 18 is a diagram illustrating an example of a functional configuration of a base station according to the embodiment. As illustrated in FIG. 18, the base station eNB includes a signal transmission unit 201, a signal reception unit 202, and a notification unit 203. FIG. 18 illustrates functional units of the base station eNB particularly related to the embodiment only and also includes at least functions (not illustrated) for performing operations compatible with LTE. Moreover, the functional configurations illustrated in FIG. 18 are examples only. The functional classifications and the names of the functional units are not particularly limited as long as the operations according to the present embodiment can be executed.

The signal transmission unit 201 includes a function of generating various signals of the physical layer from higher-layer signals to be transmitted from the base station eNB and transmitting the signals wirelessly. The signal reception unit 202 includes a function of wirelessly receiving various signals from the user equipment UE and acquiring higher-layer signals from the received physical layer signals.

The notification unit 203 notifies the user equipment UE of various items of information (setting of the SCI resource pool and the data resource pool, the number of times the user equipment UE repeatedly transmits SCI, the interval between the first SCI transmission resource pool and the second SCI transmission resource pool in the second SCI repeat transmission method, “max_offset_re,” the transmission interval meant by the predetermined one unit, and the like) that the user equipment UE uses to perform the operation of the present embodiment using the notification information (SIB) or the RRC signaling.

All of the functional configurations of the base station eNB and the user equipment UE described above may be realized by a hardware circuit (for example, one or a plurality of IC chips), and portions thereof may be realized by a hardware circuit and the other may be realized by a CPU and a program.

(User Equipment)

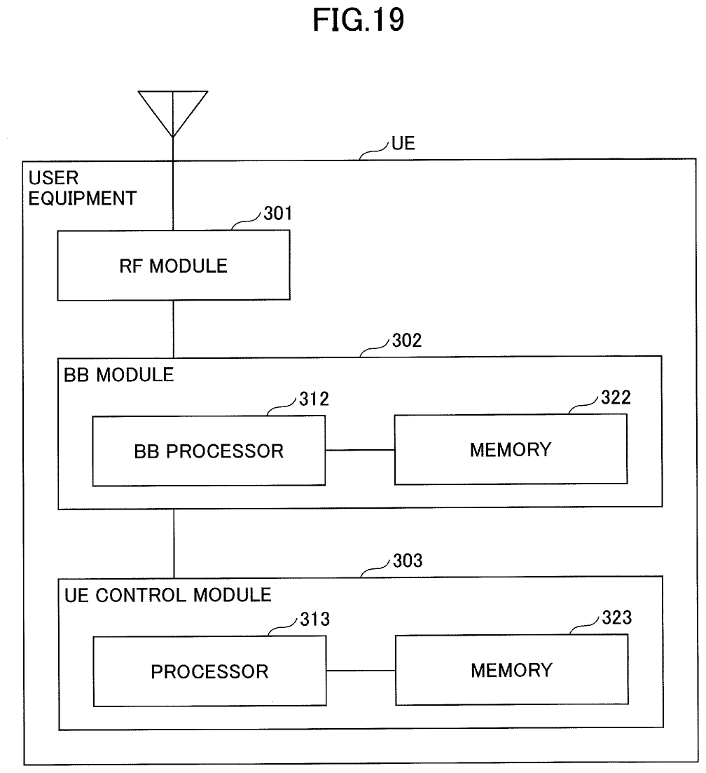

FIG. 19 is a diagram illustrating an example of a hardware configuration of the user equipment according to the embodiment. FIG. 19 illustrates a configuration more similar to an implementation example than FIG. 17. As illustrated in FIG. 19, the user equipment UE includes an RF (Radio Frequency) module 301 that performs processing on radio signals, a BB (Base Band) processing module 302 that performs baseband signal processing, and a UE control module 303 that performs processing of higher layers and the like.

The RF module 301 generates radio signals to be transmitted from an antenna by performing D/A (Digital-to-Analog) conversion, modulation, frequency conversion, power amplification, and the like on the digital baseband signals received from the BB processing module 302. Moreover, the RF module 301 generates digital baseband signals by performing frequency conversion, A/D (Analog to Digital) conversion, demodulation, and the like on the received radio signals and delivers the generated digital baseband signals to the BB processing module 302. The RF module 301 includes a portion of the signal transmission unit 101 and the signal reception unit 102 illustrated in FIG. 17, for example.

The BB processing module 302 performs a process of converting an IP packet and a digital baseband signal or vice versa. A DSP (Digital Signal Processor) 312 is a processor that performs signal processing in the BB processing module 302. A memory 322 is used as a work area of the DSP 312. The RF module 301 includes a portion of the signal transmission unit 101, a portion of the signal reception unit. 102, and the selection unit 103 illustrated in FIG. 17, for example.

The UE control module 303 performs protocol processing of the IP layer and processing of various applications. A processor 313 is a processor that performs the processing performed by the UE control module 303. A memory 323 is used as a work area of the processor 313.

(Base Station)

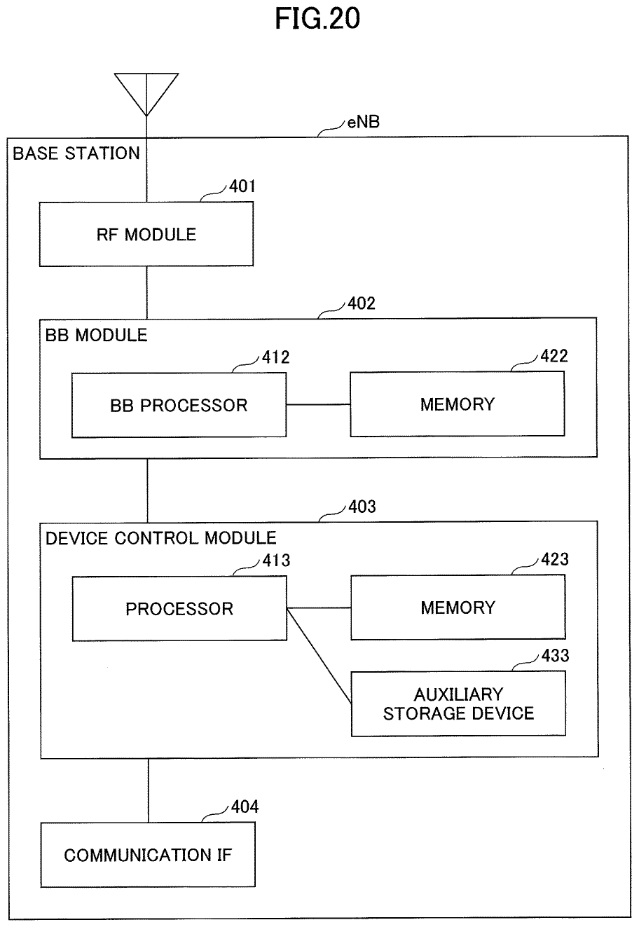

FIG. 20 is a diagram illustrating an example of a hardware configuration of a base station according to the embodiment. FIG. 20 illustrates a configuration more similar to an implementation example than FIG. 18. As illustrated in FIG. 20, the base station eNB includes an RF module 401 that performs processing on radio signals, a BB processing module 402 that performs baseband signal processing, a device control module 403 that performs processing of higher layers and the like, and a communication IF 404 which is an interface for connecting to a network.

The RF module 401 generates radio signals to be transmitted from an antenna by performing D/A conversion, modulation, frequency conversion, power amplification, and the like on the digital baseband signals received from the BB processing module 402. Moreover, the RF module 401 generates digital baseband signals by performing frequency conversion, A/D conversion, demodulation, and the like on the received radio signals and delivers the generated digital baseband signals to the BB processing module 402. The RF module 401 includes a portion of the signal reception unit 202 and the signal transmission unit 201 illustrated in FIG. 18, for example.

The BB processing module 402 performs a process of converting an IP packet and a digital baseband signal or vice versa. The DSP 412 is a processor that performs signal processing in the BB processing module 402. A memory 422 is used as a work area of the DSP 412. The BB processing module 402 includes a portion of the signal transmission unit 201, a portion of the signal reception unit 202, and a portion of the notification unit 203 illustrated in FIG. 18, for example.

The device control module 403 performs protocol processing of the IP layer and OAM (Operation and Maintenance) processing. A processor 413 is a processor that performs the processing performed by the device control module 403. A memory 423 is used as a work area of the processor 413. An auxiliary storage device 433 is a HDD, for example, and stores various items of configuration information for the base station eNB itself to operate. The device control module 403 includes a portion of the notification unit 203 illustrated in FIG. 18, for example.

### SUMMARY

According to the embodiment, there is provided a user equipment in a wireless communication system that supports D2D communication, including: a selection unit that selects a first control information resource for transmitting control information from a control information resource pool and selects a first data resource for transmitting data from a data transmission resource pool among radio resources in which the control information resource pool and the data transmission resource pool are continuously set without any limitation in a time direction; and a transmission unit that transmits control information including information that designates the first data resource using the first control information resource and transmits data using the first data resource. Due to this user equipment UE, a technique capable of performing D2D communication more flexibly is provided.

The control information resource pool may be divided into a first resource pool set to a higher frequency band than a frequency band of the data transmission resource pool and a second resource pool set in a lower frequency band than the frequency band of the data transmission resource pool, the selection unit may select the first control information resource from the first resource pool or the second resource pool, when the first control information resource is selected from the first resource pool, the selection unit may select a second control information resource from the second resource pool in a subframe later than a subframe of the first control information resource, when the first control information resource is selected from the second resource pool, the selection unit may select the second control information resource from the first resource pool in a subframe later than the subframe of the first control information resource, and the transmission unit may transmit the control information including the information that designates the first data resource using the first control information resource and the second control information resource. In this way, it is possible to realize frequency hopping of SCI using the SCI resource pools set to the upper and lower sides of the frequency range of the data resource pool and to improve the reception quality of SCI even when propagation quality in a specific frequency (a subcarrier or the like) deteriorates.

The subframe in which the second control information resource is selected may be determined based on a resource location in a frequency direction of the first control information resource. In this way, it is possible to perform control so that the occurrence of a problem (a half-duplex problem) that two user equipments UEs transmit SCI in the same subframe and one user equipment UE cannot receive SCI transmitted by the other user equipment UE is prevented as much as possible.

The second control information resource may be included in a time region different from a time region in which the first control information resource is included among time regions in which the first resource pool and the second resource pool are repeatedly set. In this way, it is possible to realize repeated transmission of SCI based on a resource pool configuration.

The selection unit may select a second data resource from the data transmission resource pool in a subframe later than a subframe of the first data resource, and the transmission unit may transmit data using the first data resource and the second data resource. In this way, it is possible to transmit the same data repeatedly and to improve the reception quality of data (MAC PDU).

The selection unit may select the second data resource so that an interval between a subframe in which the first data resource is selected and a subframe in which the second data resource is selected is larger than a subframe interval between a subframe in which the first control information resource is selected and a subframe in which the second control information resource is selected. In this way, it is possible to perform control so that the occurrence of a problem (a half-duplex problem) that a user equipment UE that transmits SCI and a user equipment UE that transmits data transmit a D2D signal in the same subframe and one user equipment UE cannot receive the D2D signal transmitted by the other user equipment UE is prevented as much as possible.

The control information may include reservation information indicating that a control information transmission resource for transmitting another control information different from the control information is to be reserved in a subframe which is a predetermined subframe later than the subframe in which the first control information resource is selected in the control information resource pool. In this way, a user equipment UE can notify the other user equipment UE of the fact that the user equipment UE is scheduled to transmit SCI at a predetermined timing and can avoid collision between the SCI transmitted by the user equipment UE itself and the SCI transmitted from the other user equipment UE.

The control information may include reservation information indicating that a data transmission resource for transmitting another data different from the data is to be reserved in a subframe which is the predetermined subframe later than the subframe in which the first data resource is selected in the data transmission resource pool. In this way, a user equipment UE can notify the other user equipment UE of the fact that the user equipment UE is scheduled to transmit data at a predetermined timing and can avoid collision between the data transmitted by the user equipment UE itself and the data transmitted from the other user equipment UE.

According to the embodiment, there is provided a transmission method executed by a user equipment in a wireless communication system that supports D2D communication, including: selecting a first control information resource for transmitting control information from a control information resource pool and selecting a first data resource for transmitting data from a data transmission resource pool among radio resources in which the control information resource pool and the data transmission resource pool are continuously set without any limitation in a time direction; and transmitting control information including information that designates the first data resource using the first control information resource and transmitting data using the first data resource. Due to this transmission method, a technique capable of performing D2D communication more flexibly is provided.

<Supplementary Explanation According to Embodiment>

PSCCH may be another control channel as long as the control channel is a control channel for transmitting control information (SCI or the like) used in D2D communication. PSSCH may be another data channel as long as the data channel is a data channel for transmitting data (MAC PDU or the like) used in D2D communication. PSDCH may be another data channel as long as the data channel is a data channel for transmitting data (a discovery message or the like) used in D2D communication.

The configurations of the devices (the user equipment UE and the base station eNB) described in the embodiment may be realized when a program is executed by a CPU (a processor) in the device including the CPU and the memory. The configurations may be realized by hardware such as a hardware circuit that includes the logics of the processes described in the present embodiment and may be realized by a combination of a program and hardware.

While the embodiment of the present invention has been described, the disclosed invention is not limited to such an embodiment, and various variations, modifications, alterations, and substitutions could be conceived by those skilled in the art. While specific examples of numerical values are used in order to facilitate understanding of the invention, these numerical values are examples only and any other appropriate values may be used unless otherwise stated particularly. The classification of items in the description is not essential in the present invention, and features described in two or more items may be used in combination, and a feature described in a certain item may be applied to a feature described in another item (unless contradiction occurs). It is not always true that the boundaries of the functional units or the processing units in the functional block diagram correspond to boundaries of physical components. The operations of a plurality of functional units may be physically performed by a single component. Alternatively, the operations of the single functional unit may be physically performed by a plurality of components. The orders in the sequence and the flowchart described in the embodiment may be switched unless contradiction occurs. For convenience of explanation of processing, the user equipment UE and the base station eNB have been explained using functional block diagrams. However, these devices may be implemented by hardware, software, or a combination thereof. The software that operates by a processor included in the user equipment UE according to the embodiment of the present invention and the software that operates by a processor included in the base station eNB according to the embodiment of the present invention may be stored in a random access memory (RAM), a flash memory, a read only memory (ROM), an EPROM, an EEPROM, a register, a hard disk (HDD), a removable disk, a CD-ROM, a database, a server, and other appropriate storage media.

In the embodiment, the SCI resource pool is an example of a “control information resource pool”. The data resource pool is an example of a “data transmission resource pool”. The SCI is an example of control information. The SCI resource pool on the upper side of FIG. 7 is an example of a first resource pool. The SCI resource pool on the lower side of FIG. 7 is an example of a second resource pool. The SCI reservation identifier is an example of “reservation information indicating that control information transmission resources are to be reserved”. The data reservation identifier is an example of “reservation information indicating that data transmission resources are to be reserved”.

Information transmission (notification, reporting) may be performed not only by methods described in an aspect/embodiment of the present specification but also a method other than those described in an aspect/embodiment of the present specification. For example, the information transmission may be performed by physical layer signaling (e.g., DCI (Downlink Control Information), UCI (Uplink Control Information)), upper layer signaling (e.g., RRC signaling, MAC signaling, broadcast information (MIB (Master Information Block), SIB (System Information Block))), other signals, or combinations thereof. Further, an RRC message may be referred to as RRC signaling. Further, an RRC message may be, for example, an RRC connection setup message, an RRC connection reconfiguration message, or the like.

An aspect/embodiment described in the present specification may be applied to a system that uses LTE (Long Term Evolution), LTE-A (LTE-Advanced), SUPER 3G, IMT-Advanced, 4G, 5G, FPA (Future Radio Access), W-CDMA (registered trademark), GSM (registered trademark), CDMA2000, UMB (Ultra Mobile Broadband), IEEE 802.11 (Wi-Fi), IEEE 802.16 (WiMAX), IEEE 802.20, UWB (Ultra-WideBand), Bluetooth (registered trademark), other appropriate systems, and/or a next generation system enhanced based thereon.

Determination or judgment may be performed according to a value (0 or 1) represented by a bit, may be performed according to a boolean value (true or false), or may be performed according to comparison of numerical values (e.g., comparison with a predetermined value).

It should be noted that the terms described in the present specification and/or terms necessary for understanding the present specification may be replaced by terms that have the same or similar meaning. For example, a channel and/or a symbol may be a signal. Further, a signal may be a message.

There is a case in which a UE may be referred to as a subscriber station, a mobile unit, subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other appropriate terms.

An aspect/embodiment described in the present specification may be used independently, may be used in combination, or may be used by switching according to operations. Further, transmission of predetermined information (e.g., transmission of “it is X”) is not limited to explicitly-performed transmission. The transmission of predetermined information may be performed implicitly (e.g., explicit transmission of predetermined information is not performed).

As used herein, the term “determining” may encompasses a wide variety of actions. For example, “determining” may be regarded as calculating, computing, processing, deriving, investigating, looking up (e.g., looking up in a table, a database or another data structure), ascertaining and the like. Also, “determining” may be regarded as receiving (e.g., receiving information), transmitting (e.g., transmitting information), inputting, outputting, accessing (e.g., accessing data in a memory) and the like. Also, “determining” may be regarded as resolving, selecting, choosing, establishing, comparing and the like. That is, “determining” may be regarded as a certain type of action related to determining.

As used herein, the phrase “based on” does not mean, unless otherwise noted, “based on only”. In other words, the phrase “base on” means both “based on only” and “based on at least”.

Also, the order of processing steps, sequences or the like of an aspect/embodiment described in the present specification may be changed as long as there is no contradiction. For example, in a method described in the present specification, elements of various steps are presented in an exemplary order. The order is not limited to the presented specific order.

Input/output information, etc., may be stored in a specific place (e.g., memory) or may be stored in a management table. The input/output information, etc., may be overwritten, updated, or added. Output information, etc., may be deleted. Input information, etc., may be transmitted to another apparatus.

Transmission of predetermined information (e.g., transmission of “it is X”) is not limited to explicitly-performed transmission. The transmission of predetermined information may be performed implicitly (e.g., explicit transmission of predetermined information is not performed).

Information, a signal, etc., described in the present specification may be represented by using any one of the various different techniques. For example, data, an instruction, a command, information, a signal, a bit, a symbol, a chip or the like described throughout in the present specification may be represented by voltage, current, electromagnetic waves, magnetic fields or a magnetic particle, optical fields or a photon, or any combination thereof.

The present application is based on and claims the benefit of priority of Japanese Priority Application No. 2016-020327 filed on Feb. 4, 2016, the entire contents of which are hereby incorporated by reference.

### EXPLANATIONS OF LETTERS OR NUMERALS

UE: User equipment
eNB: Base station
101: Signal transmission unit
102: Signal reception unit
103: Selection unit
201: Signal transmission unit
202: Signal reception unit
203: Signal reception unit
301: RF module
302: BB processing module
303: UE control module
304: Communication IF
401: RF module
402: BB processing module
403: Device control module

1. A user equipment in a wireless communication system that supports D2D communication, comprising:
a selection unit that selects a first control information resource for transmitting control information from a control information resource pool and selects a first data resource for transmitting data from a data transmission resource pool among radio resources in which the control information resource pool and the data transmission resource pool are continuously set without any limitation in a time direction; and
a transmission unit that transmits control information including information that designates the first data resource by using the first control information resource and transmits data by using the first data resource.

2. The user equipment according to claim 1, wherein
the control information resource pool is divided into a first resource pool set in a higher frequency band than a frequency band of the data transmission resource pool and a second resource pool set in a lower frequency band than the frequency band of the data transmission resource pool,
the selection unit selects the first control information resource from the first resource pool or the second resource pool,
when the first control information resource is selected from the first resource pool, the selection unit selects a second control information resource from the second resource pool in a subframe later than a subframe of the first control information resource,
when the first control information resource is selected from the second resource pool, the selection unit selects the second control information resource from the first resource pool in a subframe later than the subframe of the first control information resource, and
the transmission unit transmits the control information including the information that designates the first data resource by using the first control information resource and the second control information resource.

3. The user equipment according to claim 2, wherein the subframe in which the second control information resource is selected is determined based on a resource location in a frequency direction of the first control information resource.

4. The user equipment according to claim 2, wherein the second control information resource is included in a time region different from a time region in which the first control information resource is included among time regions in which the first resource pool and the second resource pool are repeatedly set.

5. The user equipment according to claim 2, wherein
the selection unit selects a second data resource from the data transmission resource pool in a subframe later than a subframe of the first data resource, and
the transmission unit transmits data by using the first data resource and the second data resource.

6. The user equipment according to claim 5, wherein the selection unit selects the second data resource so that an interval between a subframe in which the first data resource is selected and a subframe in which the second data resource is selected is larger than a subframe interval between a subframe in which the first control information resource is selected and a subframe in which the second control information resource is selected.

7. The user equipment according to claim 1, wherein the control information includes reservation information indicating that a control information transmission resource for transmitting another control information different from the control information is to be reserved in a subframe which is a predetermined subframe later than the subframe in which the first control information resource is selected in the control information resource pool.

8. The user equipment according to claim 7, wherein the control information includes reservation information indicating that a data transmission resource for transmitting another data different from the data is to be reserved in a subframe which is the predetermined subframe later than the subframe in which the first data resource is selected in the data transmission resource pool.

9. A transmission method executed by a user equipment in a wireless communication system that supports D2D communication, comprising:
selecting a first control information resource for transmitting control information from a control information resource pool and selecting a first data resource for transmitting data from a data transmission resource pool among radio resources in which the control information resource pool and the data transmission resource pool are continuously set without any limitation in a time direction; and
transmitting control information including information that designates the first data resource by using the first control information resource and transmitting data by using the first data resource.

10. The user equipment according to claim 3, wherein
the selection unit selects a second data resource from the data transmission resource pool in a subframe later than a subframe of the first data resource, and
the transmission unit transmits data by using the first data resource and the second data resource.

11. The user equipment according to claim 4, wherein
the selection unit selects a second data resource from the data transmission resource pool in a subframe later than a subframe of the first data resource, and
the transmission unit transmits data by using the first data resource and the second data resource.

12. The user equipment according to claim 6, wherein the control information includes reservation information indicating that a control information transmission resource for transmitting another control information different from the control information is to be reserved in a subframe which is a predetermined subframe later than the subframe in which the first control information resource is selected in the control information resource pool.
